(19) United States
(12) Patent Application Publication
(10) Pub. No.: US 2017/0300643 A1
(43) Pub. Date: Oct. 19, 2017

(54) SYSTEMS FOR FACILITATING USER ENGAGEMENT AND BEHAVIOR TO IMPROVE HEALTH OUTCOMES

(71) Applicant: Mobile Health Consumer, Inc., Palo Alto, CA (US)

(72) Inventors: Matt Bezark, Palo Alto, CA (US); Leena Fernandes, Palo Alto, CA (US); Lisa Laane, Palo Alto, CA (US); Christian Wiedmann, Palo Alto, CA (US); Ulrich Wiedmann, Palo Alto, CA (US)

(21) Appl. No.: 15/489,527

(22) Filed: Apr. 17, 2017

Related U.S. Application Data
(60) Provisional application No. 62/324,241, filed on Apr. 18, 2016.

(51) Int. Cl. G06F 19/00

(52) U.S. Cl. CPC G06F 19/328; G06F 19/3481

(57) ABSTRACT

Disclosed herein are systems, methods, and machine readable media for implementing a service for facilitating user engagement and behavior to improve health outcomes. In many populations associated with a shared health insurance plan or Health Maintenance Organization (HMO), members may become less healthy over time, or may remain at a suboptimal state of health. Individual members and the population as a whole may be nudged toward improved health outcomes with various types of interventions. Described herein are embodiments of systems and methods for associating appropriate interventions with populations who are likely to benefit from them, resulting in improved health outcomes for the group.

### RELATED APPLICATIONS

The present invention claims the priority benefit of U.S. Provisional Patent Application No. 62/324,241, filed on Apr. 18, 2016, the disclosure of which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2017 Mobile Health Consumer, Inc, All Rights Reserved.

### FIELD OF THE INVENTION

The present invention relates to apparatuses, systems, computer readable media, and methods for the provision of services concerning facilitating user engagement and behavior directed toward improving the user's quality of life and health outcomes.

### BACKGROUND

Many aspects of health care have become increasingly expensive. Organizations who are responsible for administering health care to a population of members are concerned with efficient ways to maintain or improve the health of the population while minimizing the cost involved with the effort. There is a need for new approaches for shepherding a population toward healthier behaviors—particularly where such approaches can be automated to target incremental improvements in the health of a population. Disclosed herein are embodiments of an invention that address those needs. In particular, embodiments described in this disclosure may automatically identify sub-populations that are most likely to benefit from a particular health intervention or a family of interventions, and automate the process of encouraging each member to engage with the intervention and follow through with participating in the intervention.

### BRIEF DESCRIPTION OF THE DRAWINGS

The above and other aspects and advantages of the invention will become more apparent upon consideration of the following detailed description, taken in conjunction with the accompanying drawings, in which like reference characters refer to like parts throughout, and in which:

FIG. 1A-1B shows an exemplary administrator user configuration interface, consistent with some embodiments of the invention;

FIG. 2 shows an exemplary client user interface for a home page, consistent with some embodiments of the invention;

FIG. 3A-3D shows views of an exemplary client user interface for a home page, consistent with some embodiments of the invention;

FIG. 4 shows an exemplary administrator user interface, consistent with some embodiments of the invention;

FIG. 5 shows an exemplary administrator user interface, consistent with some embodiments of the invention;

FIG. 6A-6C shows views of exemplary client user interfaces, consistent with some embodiments of the invention;

FIG. 7A-7B shows views of exemplary client user interfaces, consistent with some embodiments of the invention;

FIG. 8A-8D shows views of aspects of an exemplary health coach client user interface, consistent with some embodiments of the invention;

FIG. 9A-9D shows views of aspects of an exemplary health coach client user interface, consistent with some embodiments of the invention;

FIG. 10 shows an exemplary administrator user interface for configuring automated messages, consistent with some embodiments of the invention;

FIG. 11A-11B shows an exemplary administrator user interface for configuring automated messages, consistent with some embodiments of the invention;

FIG. 12A-12C shows an exemplary administrator user interfaces for configuring incentives, consistent with some embodiments of the invention;

FIG. 13A-13B shows exemplary administrator user interfaces for configuring a challenge, consistent with some embodiments of the invention;

FIG. 14A-14D shows exemplary client user interfaces, consistent with some embodiments of the invention;

FIG. 15 shows an exemplary administrator user interface for configuring a client insurance ID card, consistent with some embodiments of the invention;

FIG. 16 shows an exemplary administrator user interface for configuring a reimbursement program, consistent with some embodiments of the invention;

FIGS. 17A-17B, 18A-18B, 19A-19B, 20A-20B and 21 show exemplary administrator user interfaces for viewing aggregate data describing various aspects of members of a group, consistent with some embodiments of the invention;

FIG. 22 is a flow chart depicting an exemplary process for automatically performing an action with respect to an eligible user population, consistent with some embodiments of the invention;

FIG. 23 is a block diagram showing exemplary data flows for an exemplary system, consistent with some embodiments of the invention;

FIG. 24 is a block diagram showing an exemplary mobile computing device, consistent with some embodiments of the invention;

FIG. 25 is a block diagram showing an exemplary computing device, consistent with some embodiments of the invention;

FIG. 26 is a block diagram showing an exemplary computing system, consistent with some embodiments of the invention;

FIG. 27 shows an exemplary administrator user interface for configuring care gaps, consistent with some embodiments of the invention;

FIG. 28 shows an exemplary administrator user interface for configuring individual care gaps, consistent with some embodiments of the invention;

FIG. 29 shows an exemplary dashboard client user interface for a care gap resource module, consistent with some embodiments of the invention;

FIG. 30 shows an exemplary client user interface concerning a care gap, consistent with some embodiments of the invention;

FIG. 31 is a flow chart depicting an exemplary process for facilitating client user responses to care gaps, consistent with some embodiments of the invention;

FIG. 32 is a flow chart depicting an exemplary process for facilitating management of a well-being incentive program, consistent with some embodiments of the invention;

FIG. 33 shows an exemplary dashboard client user interface for available management programs, consistent with some embodiments of the invention;

FIG. 34 shows an exemplary dashboard client user interface for a care goal resource module, consistent with some embodiments of the invention;

FIG. 35 shows an exemplary client user interface concerning a care goal, consistent with some embodiments of the invention.

### DETAILED DESCRIPTION

Disclosed herein are systems, methods, and machine readable media for implementing a service for facilitating user engagement and behavior to improve health outcomes. In many populations associated with a shared health insurance plan or Health Maintenance Organization (HMO), members may become less healthy over time, or may remain at a suboptimal state of health. Individual members and the population as a whole may be nudged toward improved health outcomes with various types of interventions. Particular advantages include providing a dynamic, interactive platform for client users to be nudged toward making incremental changes that can result in a healthier population of client users, by facilitating communication about correctable health issues and opportunities, and automatically managing interventions such as incentive programs and challenges. The interactive platform additionally permits client users to initiate activities that may lead to improved health outcomes—for example, by taking a health assessment survey, comparing their biometric values with healthy values, and learning about steps that the client users can take to improve particular biometrics values that might fall outside of a healthy range. Additionally, rather than provide a static, one-size-fits-all, one-way notification like traditional automated approaches for communicating with members in a health plan, the platform described here encourages engagement and is more effective in increasing well-being in a population by offering an interactive environment for client users (e.g., directly requesting responses and interaction from client users) and a high level of configurability, so that, for example, an incentive can be configured to be offered at the optimal time for the client user (such as automatically upon the client user's registration or upon a related event personal to the client user, such as when the client user links an activity tracker to their account) rather than at the time when a human administrator decides to send out a mass email recruit participants for an incentive. Such an approach is particularly helpful and provides efficiency advantages with relatively healthy populations, in circumstances where the goal is incremental improvement at the population level. Described herein are embodiments of systems and methods for associating appropriate interventions with populations who are likely to benefit from them, resulting in an improved health outcome.

It may be appreciated that providing a platform for the holistic management of employee well-being can be associated with a healthier and happier population of employees and a more efficient use of employer-provided benefits. This application provides a specific example regarding a system for facilitating employee well-being, such as employee physical and mental health (wellness). Such a system may also be adapted to facilitate other aspects of employee well-being, such as financial health (e.g., prompts regarding financial literacy, and retirement savings/401(k)s), career advising (reminders and management of annual reviews and employee self-evaluations), and other employer-provided benefits, either in combination with health management or as a separate system.

As used herein, a “member” refers to an individual in a population served by a health insurance plan or HMO, or a population that is otherwise the subject of efforts to maintain or improve the health of the population. A “user” may be a member (e.g., a client user, who can only access configuration options for itself or, in some embodiments, dependents) or an administrator user, with access to configuration options for the population. In certain circumstances, a member and the client user may be the same individual, and in other circumstances, a client user with access to the member's account may correspond to a different individual—for example, where the client user is a person with power of attorney granted by the member, or is a parent of a minor member. In circumstances where the member and client user are different individuals, certain values associated with the client user account such as contact information may relate to the individual who is the client user, whereas other values and information, such as information regarding care gaps, may relate to the individual who is the member.

As used herein, “intervention” refers to proactively seeking a modification in the behavior of a member, for example by providing relevant information or by engaging the member in a requested activity such as a challenge to walk a certain number of steps within a period of time. Categories of interventions may include, for example, quizzes, surveys (e.g., a health assessment), reminders, notifications regarding health concerns, physical activity challenges, incentives for achieving health goal, health goal challenges, and the like. An implementation of an intervention may be, for example, a server application that prompts and processes input and provides a user interface via a mobile device or personal computer that facilitates the intervention.

As used herein, an “incentive” refers to a reward contingent on completion of a task. The reward may be monetary, nominal, or some other type of value. The task may be, for example, filling out a survey, obtaining a flu shot, walking 10,000 steps in a week, or losing a specified amount of weight in one month.

Certain interventions involve first identifying a sub-population that is most likely to benefit from the intervention, and then executing the intervention with respect to each member of the identified sub-population. The identifying step may involve requesting information from the population, such as updated biometric measurements, and determining whether each respective member is appropriate for the intervention based on that information, and/or making determinations based on data already available to the system (such as biographical information or information related to health insurance claims). In certain embodiments, the identifying step may involve recognizing a triggering event based on a user's interaction with the system, such as the user opening/reading a message, registering a login with the system, logging in to the system, viewing an ID card, taking a quiz, or requesting/viewing a specified category of information in the system. Executing an intervention may involve, for example, providing notice or requesting participation from the member, providing a user interface for participation in the intervention, tracking the member's progress, facilitating payment/provision of a reward or incentive, or providing reminders regarding the intervention.

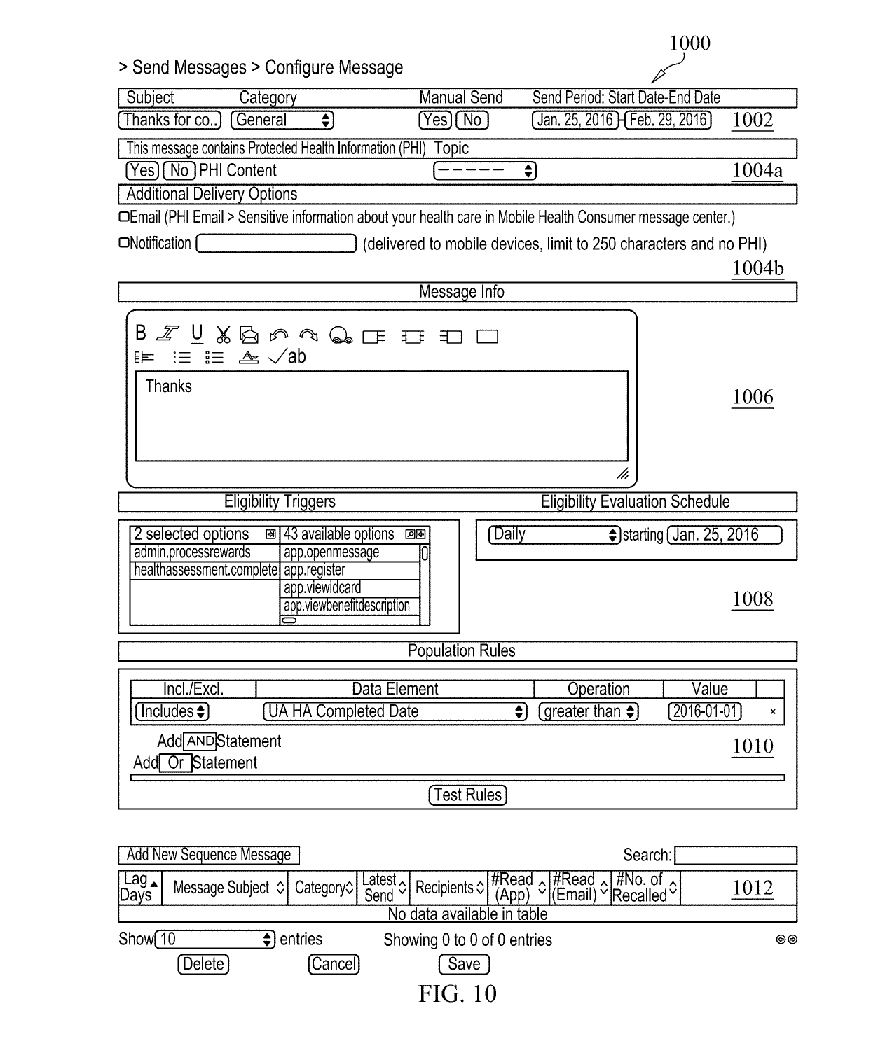

In certain embodiments, the system monitors the status of members in real time by polling care gap information on each member to determine if a gap in health care exists and automatically react to such a gap if found. For example, the system may poll the status of each member once a week, once a day, twice a day, once an hour, twice an hour, or each minute to evaluate whether a care gap exists. In certain embodiments, the system may retrieve care gaps for a user based upon the occurrence of a trigger event, such as the member logging in via a client user interface. In certain embodiments, care gap information for one or more members is retrieved from an external system or provider. A “care gap” may refer to a discontinuity in expected health care—for example, certain members who have not had an office visit for at least a year, certain female members without a Pap smear in the last two years, certain members who have been hospitalized due to short-term complications of diabetes. For a given identified care gap, an appropriate intervention (i.e., a care-gap intervention) may be to provide one or more reminders to the member to schedule an office visit, obtain a flu vaccine, or re-fill a prescription, optionally in conjunction with an incentive. For more serious care gaps, an automated notification to a medical care team or a request for follow-up information from a medical professional may be warranted. The system's handling of care gaps is discussed further in connection with FIGS. 10 and 27-31.

In certain embodiments, execution of the intervention must ensure the member's privacy by preventing third party access to a member's health information or certain information relating to the intervention, including preventing administrator access to certain information. In certain embodiments, aggregate data is provided to administrator users, but not individual data. In certain embodiments, member data (e.g., member health information) is stored in encrypted form. In certain embodiments, member data is transmitted in encrypted form (e.g., while transmitted from a member's mobile device to a remote server or vice versa).

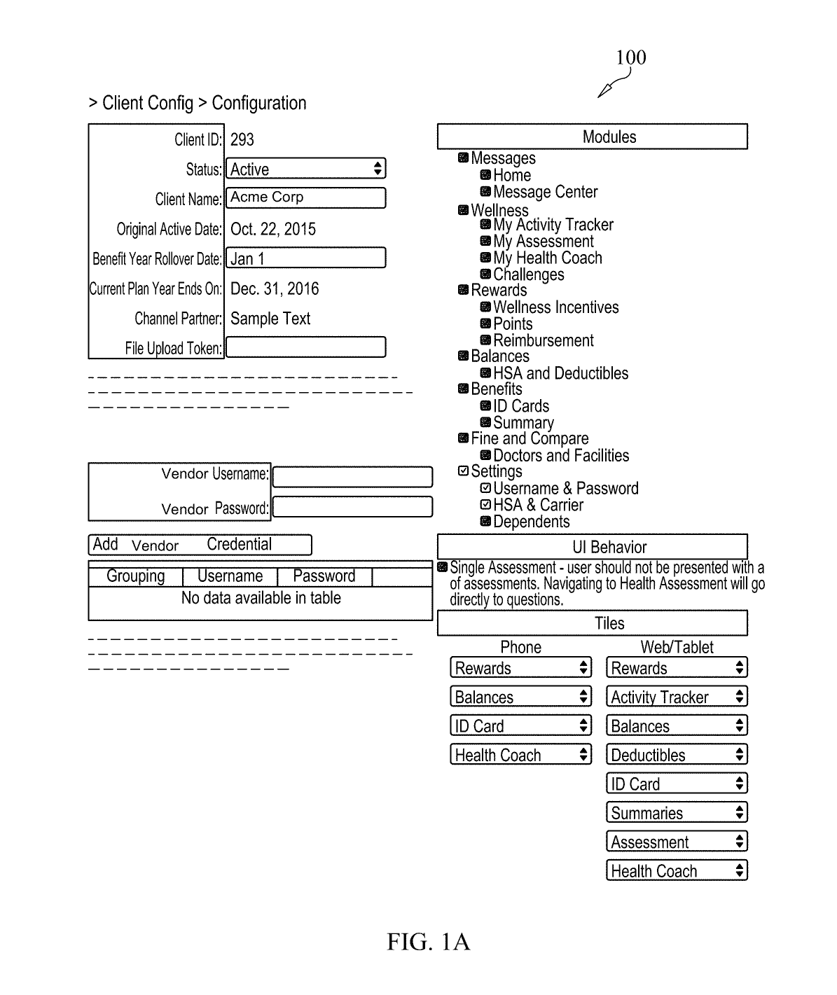

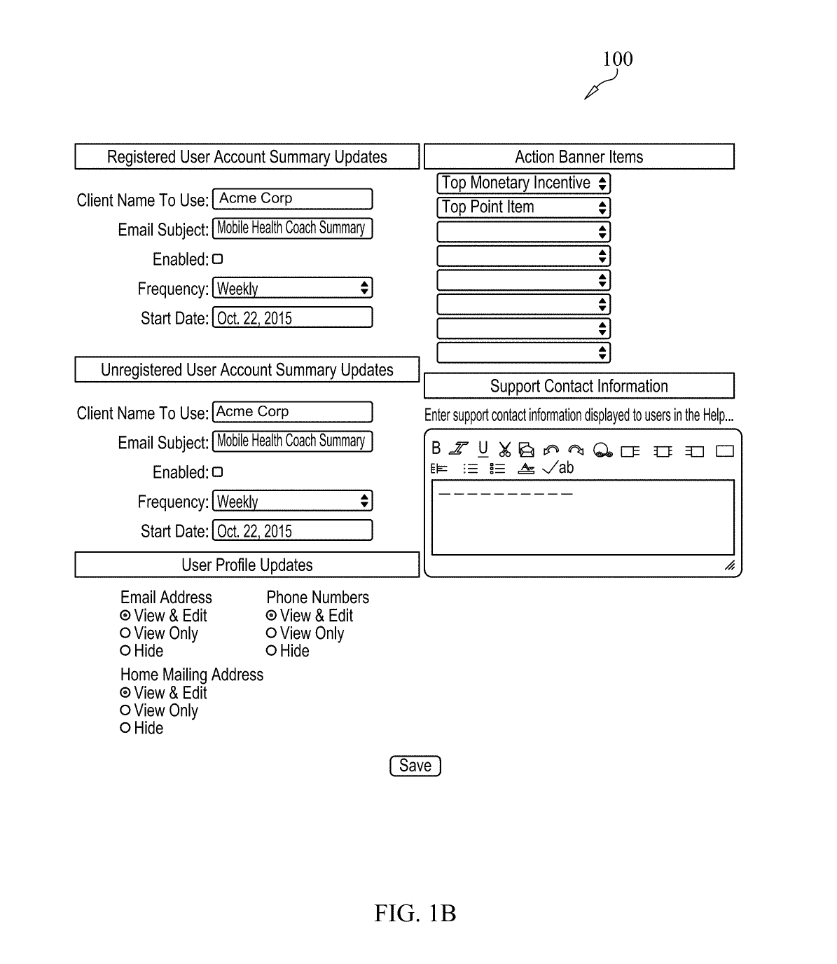

FIG. 1 provides an exemplary view of an administrator user configuration interface 100 for an embodiment of the system. Such a configuration page may provide an administrator user interface for configuring aspects of the client user's user experience. In certain embodiments, any text as displayed in an administrator user interface may represent a selectable element that links to an interface for obtaining further information or configuration on the subject of the text. As shown, the user interface allows selection of certain modules and categories of modules that may be part of the client user experience. Each module may be associated with one or more client user interface providing access to various functionalities of the system. For example, as shown in FIG. 1A, modules may fall into the categories of: Messages (e.g., indication of messages on home screen, message center), Wellness (e.g., my activity tracker, my health assessment, my health coach, challenges), Rewards (e.g., wellness incentives, points, reimbursement), Balances (e.g., view balance for health savings account (HSA) and deductibles), Benefits (e.g., view insurance ID card, benefits summary), Find and compare (e.g., obtain a list of all nearby or in-network doctors and/or facilities such a hospitals or urgent care facilities and related information), and Settings (e.g., edit member profile, reset or view username/password, HSA and carrier, dependents). Embodiments of these modules are described in more detail below.

The exemplary configuration page shown in FIG. 1A additionally provides an option for selection of visible tiles—tiles may represent links or selectable elements displayed on a home page or landing page of a client user interface, allowing quick access to a particular module or other functionality of the system. Available tiles may include rewards, balances, ID Card, Health Coach, Activity tracker (link to smart watch, other types of activity trackers), deductibles, summaries, health assessment, points, profile, doctors, hospitals, urgent care, and challenges. In certain embodiments, the tiles or available modules may correspond to surveys, or one or more particular care gap modules. In certain embodiments, tiles may be configured with a custom label and/or image. Embodiments of these options are described in more detail below. User interface 100 provides separate options for configuring the landing page for a smartphone (“phone”) and a tablet or larger screen device (“Web/Tablet”)

The exemplary configuration page shown in FIG. 1B additionally provides an option for selection of featured items (e.g., “Action Banner Items”)—such items may be selectable elements that are featured on a home page or landing page of a client user interface, and may include explanatory prompts or text to encourage interaction. Featured elements may include, for example: Top monetary incentives (e.g., submit/participate in health assessment for $100), Top point item, request to provide missing information (e.g., email address, phone number, mailing address), or: Has not uploaded any receipts, receipts to submit, rejected receipts (e.g., for calculating HSA balance). Embodiments of these options are described in more detail below.

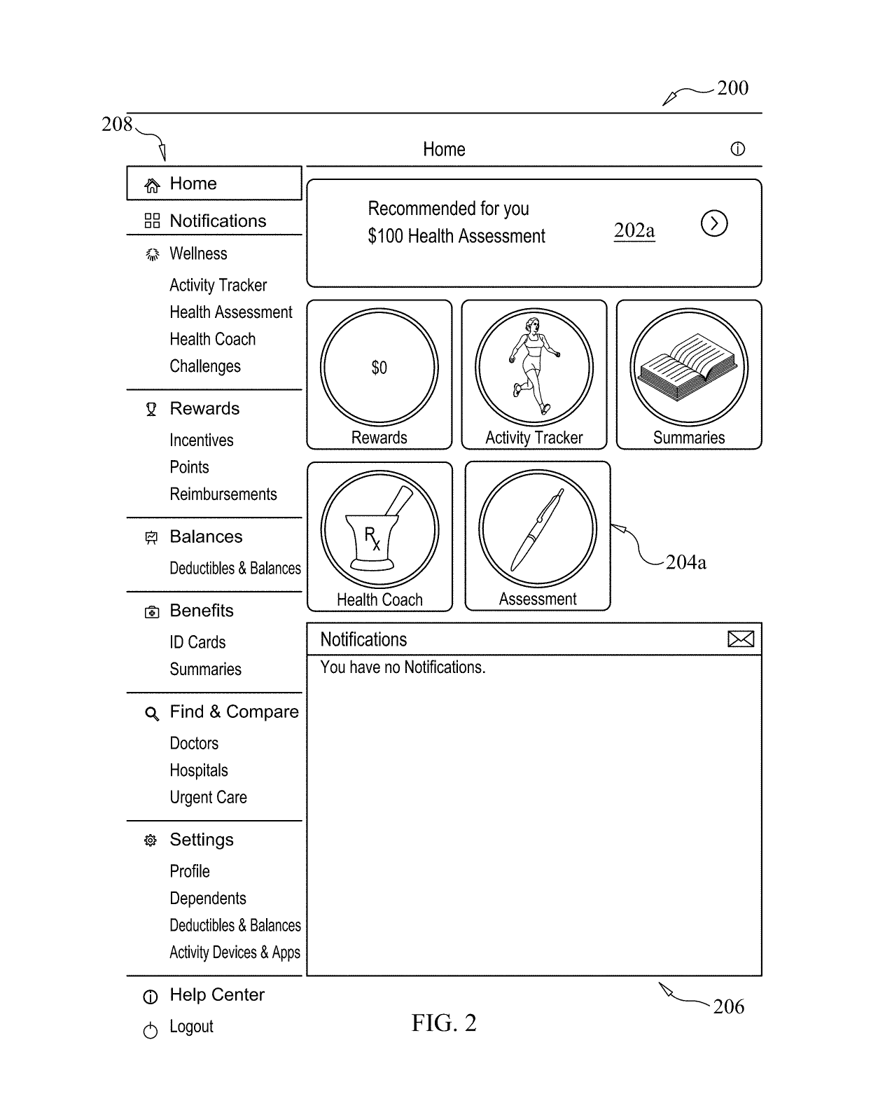

FIG. 2 shows an exemplary view of a client user interface 200 for a home page or a landing page, for example as viewed via a web browser on a laptop or a tablet computer. A variety of user interfaces are contemplated that include pluralities of various types of selectable elements, that, when selected, present the user with a module related to the service for facilitating user engagement. For example, client user interface 200 includes an exemplary action banner 202, e.g., action banner item 202a, which, when selected, presents the user with a user interface for taking a Health Assessment. In this example, completing the Health Assessment is associated with an incentive reward of $100. Client user interface 200 further includes series of tiles 204 including tile 204a, which, when selected, presents the user with a user interface for taking a Health Assessment. Client user interface 200 further includes a home screen message panel 206 for displaying messages. In certain embodiments, any message may be displayed via a panel 206; in other embodiments, only the subject line may displayed, or a category of message may never be displayed via a home screen message panel. Client user interface 200 further includes a navigation panel 208, which presents selectable elements that when selected, present the corresponding module. The presence or absence and features of each of these user interface elements may be configured via a user interface such as the configuration page of FIG. 1.

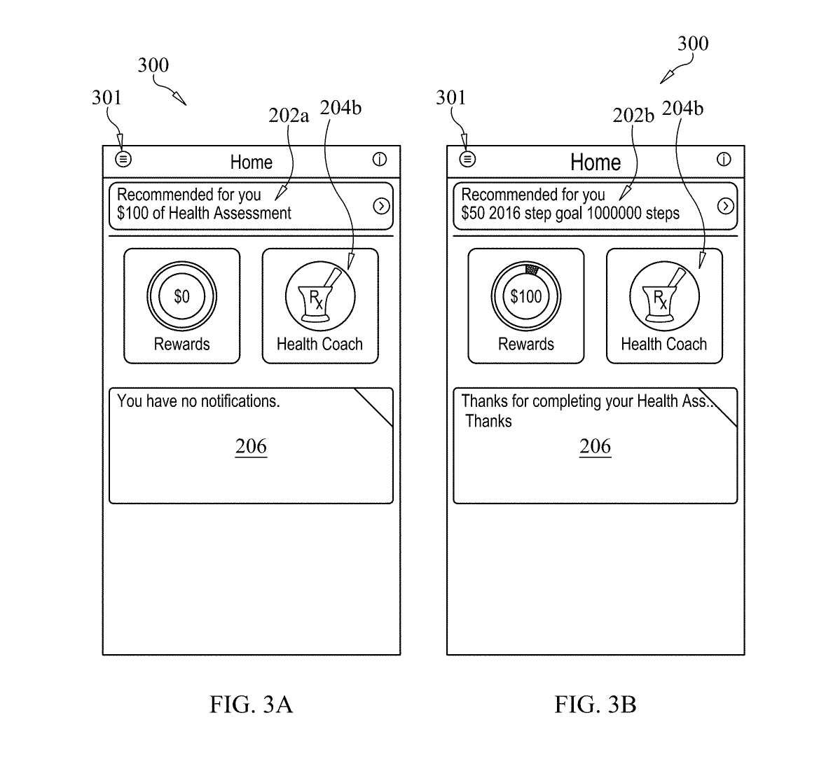

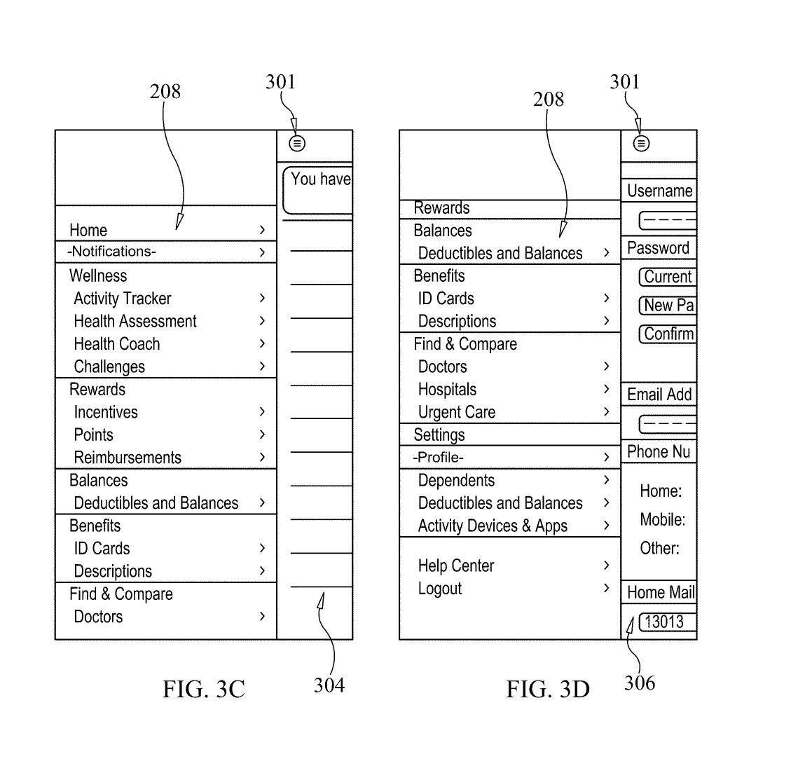

FIG. 3A and 3B show two views of an exemplary client user interface 300 for a home page or a landing page, for example as viewed via a mobile device with limited screen space, such as a smart phone. FIG. 3A shows another embodiment of action banner item 202a. FIG. 3B shows a different action banner item 202b, which, when selected, may enroll the user in a walking challenge incentive. In certain embodiments, home page user interface 200 or 300 may present an action banner item 202 or another featured item based on a list of available options that is ranked according to the selection of an administrator user. In certain embodiments, the presented item may be automatically selected according to a set of rules resulting in a recommended item—for example, (1) based on whether the item is associated with a feature for which the client user is a member of the eligible population (e.g., where the feature is membership in a particular health plan, association with a particular employer, or having an address in a particular geographic region); (2) based on whether a particular event has occurred, such as the user completing a previous task, or viewing a particular message; or (3) based on the value of an incentive associated with the item, such as a cash payout or a number of points, ranked highest to lowest; or (4) combinations of these rules. The presented item may also be shown newest to oldest, or oldest to newest, or in accordance with the ordering specified in a list of items. User interface 300 presents a series of tiles 204, including tile 204b, which when selected presents the user with a user interface for a health coach (described below). User interface 300 also presents a home screen message panel 206. In certain embodiments, the content of message panel 206 may be automatically selected according to a set of rules.

As used herein, the term “rules” refers to instructions that define automatic behaviors of the service described herein, such as defining the features of eligibility trigger events and other predicate conditions, and the one or more actions that occur upon occurrence of the event or predicate conditions, or the content of a resource presented to a particular user under a particular circumstance. For example, a rule may be configured to (1) determine whether to present a particular selectable element corresponding to a module or a particular intervention, (2) dynamically formulate content in a message, and (3) determine when and to whom a message should be sent. As used herein, a “trigger event” is a circumstance concerning a client user's interaction with the system. The circumstance may cause a client user attribute to change value (for example, upon the user viewing a particular message, a related client user attribute may change from false to true). In certain embodiments, trigger events may also be caused by an administrator user.

FIG. 3C and 3D show two views of exemplary navigation panel 208, as displayed in a client user interface. In certain embodiments, for example on devices with limited screen space, navigation panel 208 may slide out from the side of the screen upon selection of navigation control 301. Navigation panel 208 permits quick access to various user interfaces associated with modules of the system. The selectable items presented in panel 208 may be configured using, for example, configuration interface 100. As shown in FIG. 3C, selection of “Notifications” in panel 208 causes the user to be presented with a message center user interface 304 (partially shown), where messages may be viewed and managed (e.g., deleted). A message center user interface may provide a listing of messages that have been delivered to the client user, display the content of individual messages, and combinations of both. As shown in FIG. 3D, selection of “Profile” in panel 208 causes the client user to be presented with a profile user interface 306 (partially shown), where certain aspects of the user's profile may be edited, including the user name, password, and contact information.

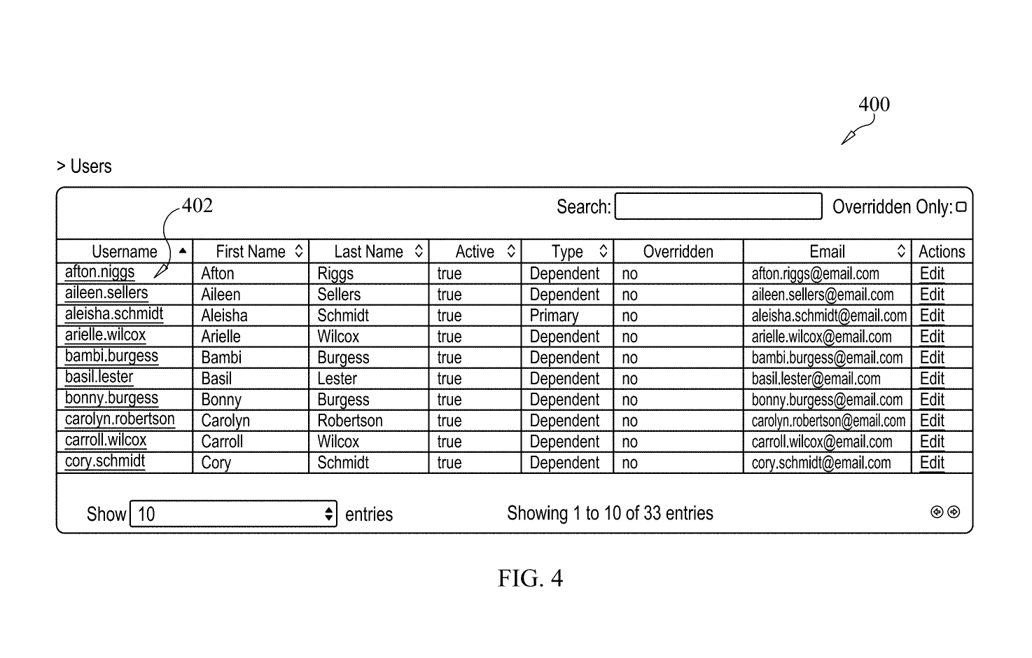

FIG. 4 shows an exemplary administrator user interface 400 associated with an exemplary population of members—for example, a population associated with an employer's health plan. Each listed member has an associated client user account. Members may be primary members (e.g., employees) or dependent members (e.g., relatives of the primary member). User interface 400 may support searching users in the population using text present in the name or profile associated with each client user. It may further support sorting the users according to various attributes. Selection of a single member, e.g., via link 402 or a corresponding “edit” link will cause the administrative user to be presented with a user interface such as user interface 500.

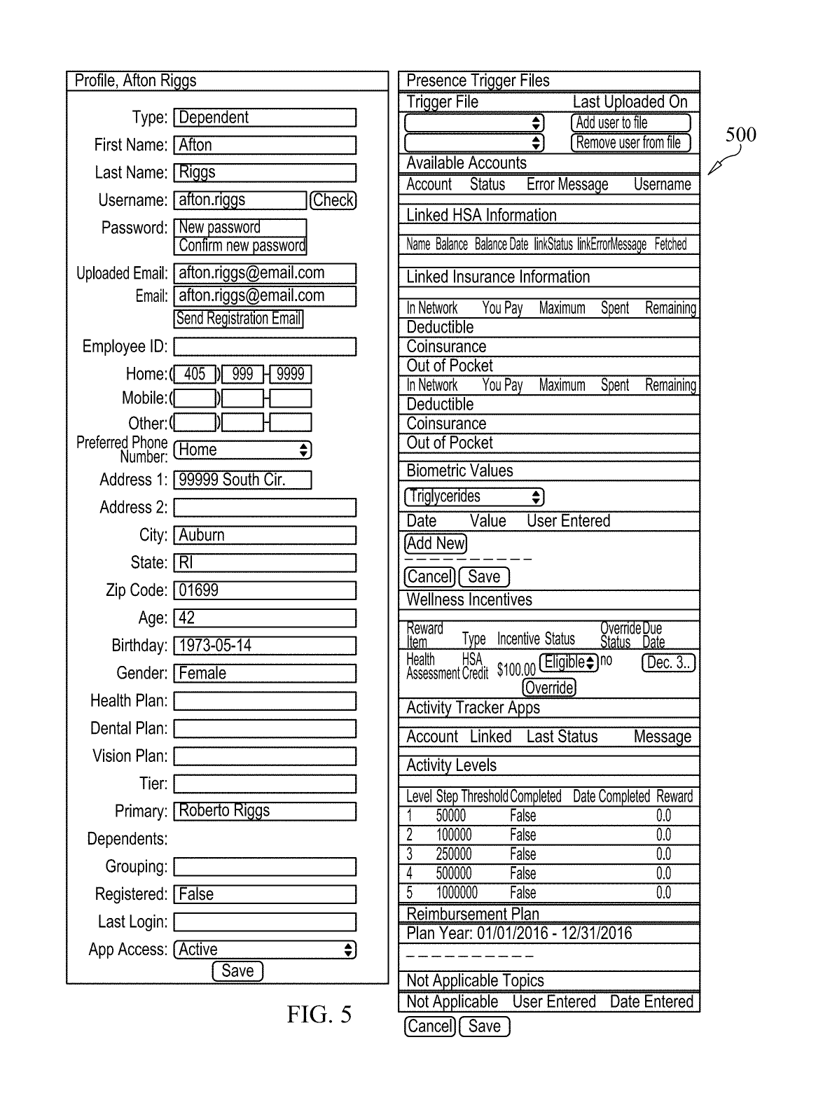

FIG. 5 shows an exemplary administrator user interface 500 associated with a single member or client user. User interface 500 may include biographical information, including listed dependents and the user's health, vision, and dental plan information. User interface 500 may further include linked HSA information and links to third party information. User interface 500 may further include biometric values such as the most recent blood pressure, height, or cholesterol measurements provided to the system, and whether a user has associated an activity tracker. The interface may also provide information about interventions such as wellness incentives and challenges (eligibility and/or participation and achievements). In certain embodiments, some or all of the elements of user interface 500 are unavailable to the employer.

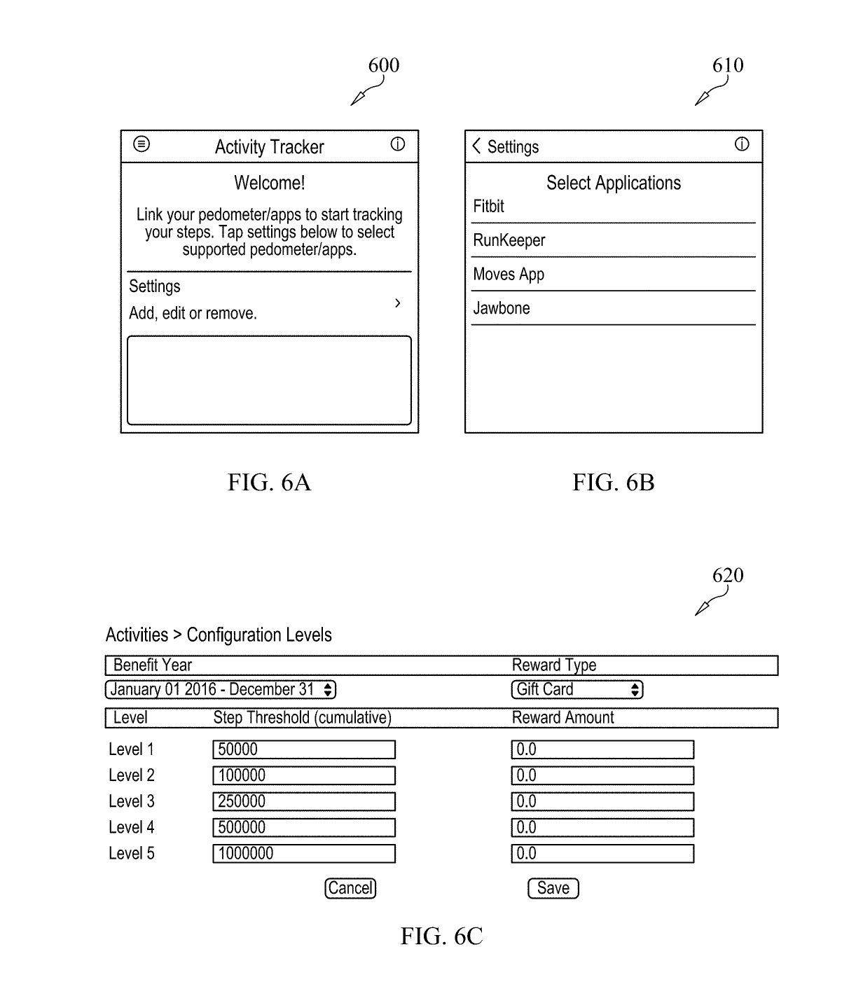

FIG. 6A and 6B show views of exemplary client user interfaces 600 and 610 for associating an activity tracker with a user. An activity tracker is a software application or member-worn device that monitors activity, such as steps taken or minutes of exercise. In certain embodiments, upon associating an activity tracker with the system, the system will obtain measures of the member's activity from the activity tracker, which may then be used to evaluate the individual activity of a member, or the aggregate activity of a population of members. Such measures may additionally be used to execute interventions, such as activity challenges, as described with respect to FIG. 6C. FIG. 6C shows an exemplary administrator user interface 620 for configuring activities. For example, user interface 620 may be used to configure aspects of an incentive—e.g., during a particular time period (e.g., 2016 benefit year), if a member reaches certain levels of an activity goal, the member will receive a reward. For example, user interface 620 may be used to associate particular step thresholds with levels of the activity goal, and may set particular reward amounts to pay or otherwise transfer to the member upon the member reaching each level (as measured, for example, by an activity tracker, or obtained via member/client user self-reporting). The rewards may be configured to be, for example, an amount of HSA credit, a dollar health insurance premium reduction, cash, gift card, or points (e.g., where aggregate points above a threshold or rate of increase may lead to presentation of the user with a badge or nominal award). In certain embodiments, if a client user's activity is lower than expected or lower than a threshold, such circumstances may trigger an intervention in which the user is encouraged to increase their activity, optionally in conjunction with an incentive.

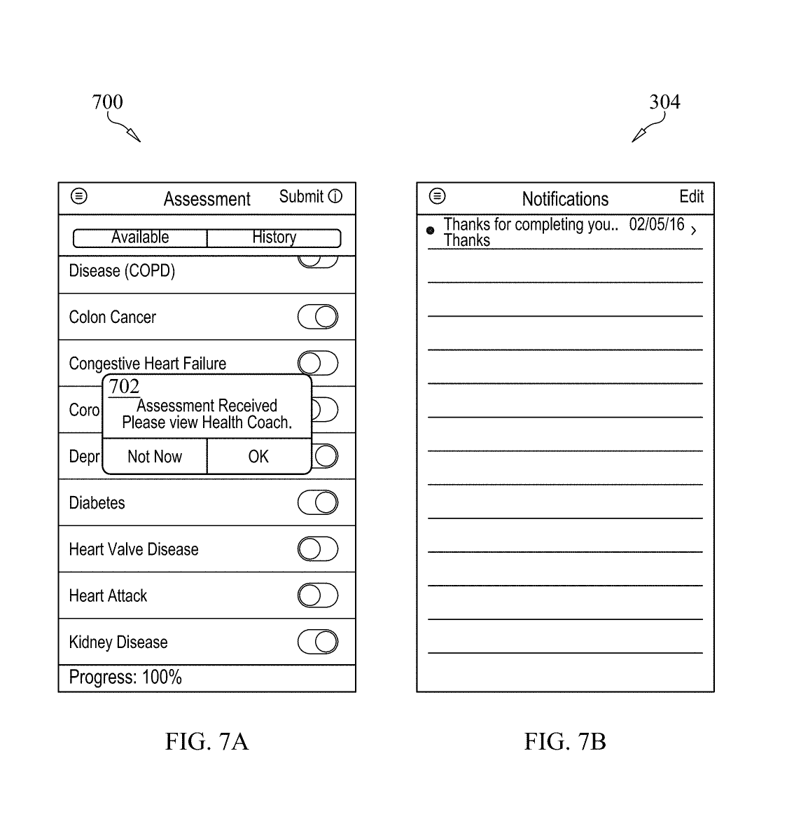

FIG. 7A shows a portion of an exemplary mobile client user interface 700 for completing an exemplary health assessment. A health assessment may be a series of yes/no, multiple choice, or fill-in the blank questions regarding a member's health status, including the member's history of diseases, cholesterol levels, weight, height, and blood pressure values. Such information may be used to provide the user with information regarding health risks, for example via a health coach module. As shown in FIG. 7A, the client user has completed all of the questions in the health assessment and has submitted the answers, and in response has received an instruction to view the health coach. Such an instruction may be received via an alert message 702 as shown in FIG. 7A, in which selecting “ok” will present the user with the health coach user interface, and selecting “Not Now” may present the user with a landing page such as UI 300. FIG. 7B shows a different engagement technique, in which upon completion of the health assessment, a message was automatically sent to the user's message center (viewable via user interface 304, for accessing messages). In certain embodiments, such a message may encourage the user to view the health coach, and may provide information or analysis based on the answers to the questions in the health assessment. In certain embodiments, after a certain period of time has elapsed, such as 6 months or one year, a user may receive a request to revise or revisit the health assessment. Where a user has only partially provided values in the health assessment, the user may periodically receive reminders to complete it, for example every day, week, or month.

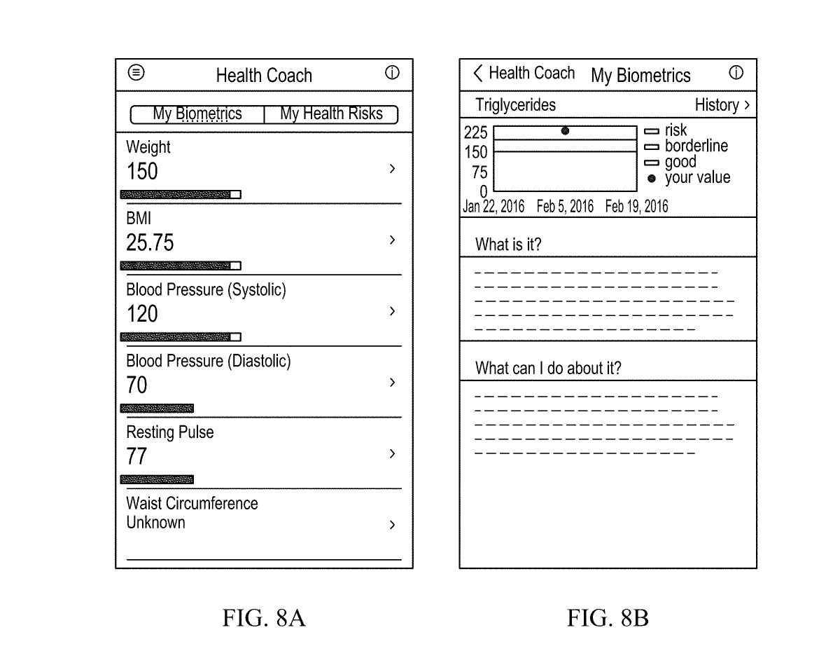

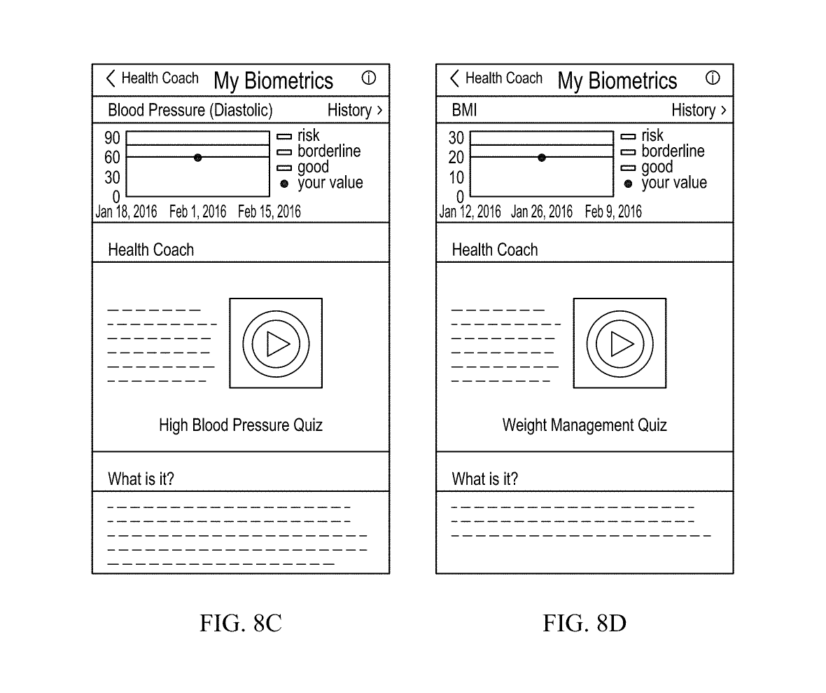

FIG. 8A-D shows four views of aspects of an exemplary health coach client user interface. A health coach may provide personalized information regarding a member's health to the client user. Such information may be based on automated analysis of information provided by the client user to the system. For example, in FIG. 8A, in a “my biometrics” view, values such as the client user's weight, body mass index, blood pressure, resting pulse, and waist circumference (obtained via a health assessment) is displayed with a comparison to benchmark values. For example, appropriate benchmark values (e.g., based on the user's gender, age, height, and/or other biographical and biometric values) are obtained from a reputable source such as the National Institute of Health. Client values that fall into various risk categories (good, borderline, or risky) relative to benchmark values may be identified via the user interface using color coding or other indicators. In FIG. 8B, 8C, and 8D, respectively, the client user has selected the biometric value “triglycerides”, “blood pressure (diastolic)” and “BMI” from the “my biometrics view” of FIG. 8A, and has been presented with associated customized information such as a graphical indicator of where the user value falls with respect to risk categories (including values provided on dates in the past), in order to provide the client user with a customized, graphical view of the trend with respect to that particular biometric. Such user interfaces may additionally provide information about the relevance of the biometric value to health, listings of past values provided by the user, and access to additional interactive content, such as quizzes or surveys, and passive content, like videos or textual commentary on health-related issues and measurements.

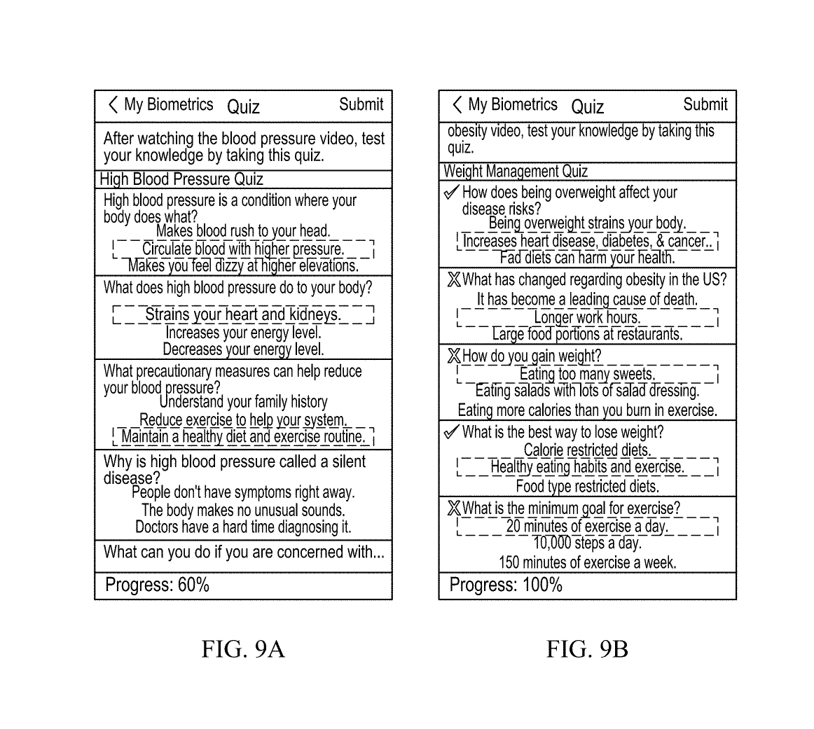

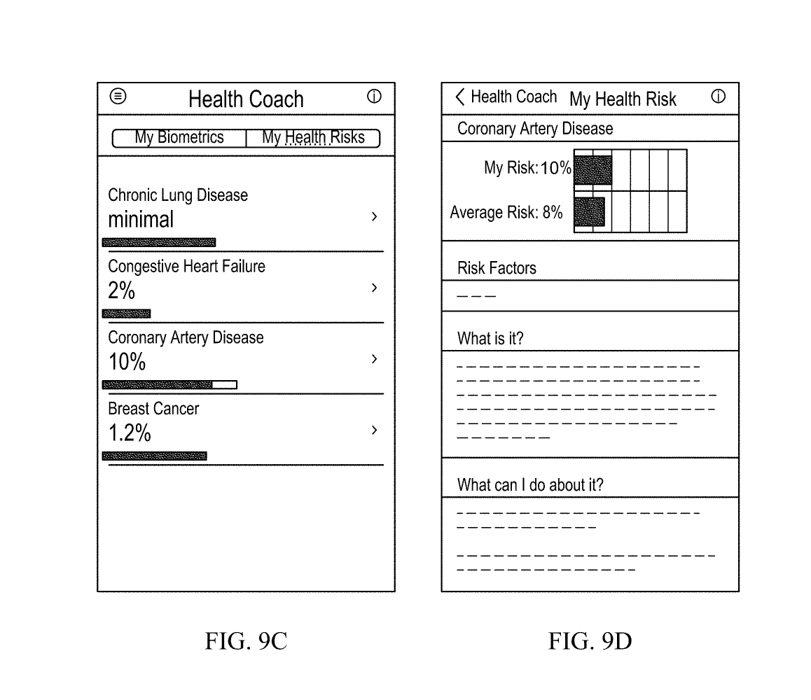

FIG. 9A-D shows four views of aspects of an exemplary health coach client user interface. FIG. 9A shows an exemplary quiz that may be accessible from a health coach view regarding blood pressure, such as the user interface shown in FIG. 8C. In certain embodiments, the quiz may provide a progress indicator as the client user provides answers to the questions. As shown in FIG. 9B, a quiz may automatically show indicators of correct and incorrect answers upon submission of one or more answers. In certain embodiments, all or some specified fraction of the responses must be revised to be correct before a quiz may be deemed complete. In certain embodiments, a client user may receive an incentive upon completion of a quiz, such as points or a monetary reward.

In certain embodiments, the service may request that the member complete a survey. A survey is a sequence of questions that prompt responses from the user, for example multiple choice or yes/no answers, or free-form text responses. In certain embodiments, the particular sequence of questions may be automatically determined based on the value or information provided in a response to an earlier question in the survey—for example, an affirmative response to a question about a history of heart attacks may prompt a series of questions about the details of the history of heart attacks, and a negative response may result in no further questions about heart attacks. User interfaces may be provided for configuring such a survey, including configuring rules that define questions that are conditional on the values or aspects of previous responses.

FIG. 9C shows an exemplary health coach user interface regarding health risks. In certain embodiments, based on information provided to the system (for example, biographical information via a user profile or registration by an employer or health insurer, or biometric values provided via a health assessment) various health risks for the client user may be calculated based on risk models sourced from reputable sources such as the National Institute of Health or the Mayo Clinic. An automatically calculated risk value may be classified into a category of risk such as low, medium, or high, and may be displayed accordingly using color and graphics to indicate the magnitude of the risk. Selecting a particular calculated risk value may present the user with a user interface such as the exemplary view shown in FIG. 9D, providing additional detail about the risk calculation and how the client user compares to an average risk, as well as suggestions for minimizing the estimated risk value. In certain embodiments, all or some of the information and analysis associated with the health coach is unavailable to the employer, third parties, and other specified parties.

FIG. 10 shows an exemplary administrator user interface 1000 for configuring automated messages to be sent to client users.

A “message” refers to an internal communication addressed to a particular client user of the system. In certain embodiments, the same message may be addressed to multiple client users. In certain embodiments, messages must be accessed via a user interface of the system, and are unavailable to access by third party software or user interfaces. As described with respect to FIG. 3C and FIG. 7B, users may access messages from a message center, and in certain embodiments, such as client user interface 200, portions of messages or entire messages may be displayed on a client user's home page or landing page (e.g., after logging in using credentials). In certain embodiments, messages are different from emails that may be delivered to external email addresses. In certain embodiments, messages are maintained in encrypted form, and such messages must be decrypted in order to be viewed. In certain embodiments, particular categories of messages are treated with higher levels of security or attention to privacy—for example, a message containing protected health information (PHI) may be associated with different delivery options. For example, the entirety or portions of the content in a message containing PHI may be ineligible for inclusion in an email for delivery to an external email address, or for inclusion in a communication to a mobile device using a text/short messaging service such as MMS (Multimedia Messaging Service), SMS (Short Message Service), iMessage™, or the like. User interface 1000 includes PHI options 1004a,b for configuring such a feature. In certain embodiments, a user may be notified of a new message within the system using an external email, text/short messaging service, or an alert message on a device; such notifications may duplicate and include portions or the entirety of the content of the message (e.g., as accessible via the system's message center), and may direct the client user to view the message via the system's message center. In certain embodiments, the system may notify a client user using an email and/or push notification in lieu of a message or in addition to a message. In certain embodiments, the system may prepare and send emails in at least the following circumstances: (1) Non-PHI messages may include the complete content of a corresponding message in an email. Email content may be configured using the functionality of content editor 1006, and may link to a mobile app or online client portal associated with the service. Emails may serve as a hook to encourage client users to engage with the service via the mobile app and/or online client portal. (2) A generic email message may be prepared and sent to inform a client user that a secure message is available. (3) Emails may be used for periodic status updates, letting the client user know how many unread messages, open care gaps, unearned incentives, and the like are waiting for the user within the system.

Protected health information is defined in the U.S. Health Insurance Portability and Accountability Act (HIPAA), and may include information about health status, provision of health care, or payment of health care that is linked to a specific individual, and may concern, for example, patient names, geographical identifiers, dates directly related to an individual, phone numbers, email addresses, social security numbers, health insurance beneficiary numbers, and account numbers.

In certain embodiments, the system may be configured to automatically send a particular message to each eligible user at least once, for example, at least once during a time period (such as a benefit year). This feature may be useful where it is important that a message reaches all client users, or all users that meet a particular set of requirements, but where users may enroll or become registered at various time points during the time period. User interface 1000 includes send period options 1002 for configuring such a feature.

User interface 1000 includes content editor 1006 for providing and configuring the appearance and formatting of content, including text and graphics, for the message. In certain embodiments, the content may be formulated dynamically based on rules, including substituting a variable provided to the content editor with textual or graphical content based on the circumstances of the message, including the time or date, biographical or medical information about the client user, or other available parameters. In certain embodiments, such dynamic formulation of content (e.g., configuration of templates or conditional formatting using the functionality of content editor 1006 and its constituent content editing tools) may be configured for any resource or subset of resources of the system, including, for example, configuring the content displayed in incentive pages, care gap descriptions, care gap titles, resource pages, reimbursement plan ineligibility messages, ID card fields, messages, and emails. In certain embodiments, content editor 1006 may support conditional templating, in which, for example, content is displayed to the client user only if a particular variable has a particular value, or if the variable is nonempty. For example, information about a client user's vision plan is displayed or alternative content is displayed, as appropriate, in the following example:

{{190 user.VisionElection}} I Your vision election is {{user.VisionElection}}.
{{/user.VisionElection}}
{{̂ user.VisionElection}} You have not elected to have vision coverage.
{{/user.VisionElection}}

In another example, a comparison of a variable with a specific value controls whether content is displayed:

{{#user.VisionElection_is_VSP}} You can get a discount on eyewear with your VSP benefits.
{{/user.VisionElection is VSP}}

In certain embodiments, content editor 1006 may support conditional formatting (e.g., display of bolding or emphasis in the content based on a variable) and calculations operating on variable, such as calculating and displaying resulting dates (e.g., calculating how many days from today a date variable's value is). In certain embodiments, the functionality of content editor 1006 may be used to configure the content displayed in a resource (e.g., a page or view within a mobile app or client user website) and/or other client-user facing aspects of the service. In certain embodiments, conditional templating and/or conditional formatting are configurable using drop down menus or other controls listing available variables and formatting options.

In certain embodiments, an administrator user may configure the system to automatically prepare and deliver a message in response to an eligibility trigger event—e.g., an event based on the client user's interaction with the system.

Eligibility trigger events may be used to trigger various automatic actions taken by the system. Trigger events may include, for example, a client user causing the system to open a particular message or any message, register an account with the system, log the user in to the system, present an ID card user interface (UI), present a benefit description UI, update one or more biometric values, deem the user eligible for a reward or reimbursement, deem the requirements for an award are complete, deem the user ineligible for a reward, update user biographical information, deem the user has reached a particular level of points, deem the user has passed or failed a quiz, present a health risk UI, receive the user's search for a physician or hospital or urgent care facility in a relevant UI, send an invite to a dependent to register with an account, link a health insurance carrier, link a HSA account, link an activity tracker, update activity data, complete a challenge milestone, partially complete a health assessment, complete a challenge, register participation in a challenge, register that a user is on the leaderboard for a challenge, register that a user is eligible for a challenge, register that a message was delivered, register that a message was deleted, register that a message was recalled, register that a reimbursement request was approved or rejected, or register that a care gap was identified or closed.

In certain embodiments, whether a client user is eligible for a message may be evaluated only once, or on a defined frequency (e.g., a set schedule), for example, daily, weekly, monthly, quarterly, or yearly. User interface 1000 includes eligibility options 1008 for configuring these features—e.g., associating a particular message with an eligibility trigger event, or determining when eligibility for a message should be evaluated.

In certain embodiments, the system may be configured to evaluate combinations of one or more rules in order to determine whether a client user is a member of the population that should receive a particular message. Each rule may be used to determine a set of client users that should be included or excluded from the population of recipients. Rules may be configured to select all members associated with an attribute or data element that is greater than, less than, or equal to a test value, or that matches or contains a string. Rules may be combined using “AND” and “OR” operators. In certain embodiments, rules may be configured to compare two or more attributes or data elements—i.e., to evaluate two or more variables in the same expression. For example, an expression may test whether first variable is greater than a second variable—e.g., whether a client user's Jan. 1, 2015 weight attribute is greater than a user's Jan. 1, 2016 weight attribute—or subtract the second variable from the first variable. User interface 1000 includes population rule options 1010 for configuring these features. In certain embodiments, the rules constructed using the population rule options (controls) may be internally represented using a Boolean expression tree. For example, the tokens in an expression may be represented as nodes in the tree, such that leaf nodes are attributes/data elements, and internal nodes are operators. The expression may be evaluated using a recursive algorithm that traverses the tree.

Population rule options may be used to determine a client user's membership in a population, so that the system may be configured to automatically execute an action based on the determination. Population rule options may operate on various categories of client user/member attributes or data elements, including, for example: client user attributes, health statistics, gaps in care, health risks, health assessment answers, incentives, reimbursements, message configuration sequences, quizzes, activity plan levels.

Client user attribute data elements may include, for example: Health Assessment Completed Date, Health Assessment Completed Date (Days Since), Biometrics Completed Date, Biometrics Completed Date (Days Since), Last Login Date, Last Login Date (Days Since), Medical Effective Date, Medical Effective Date (Days Since), Medical Termination Date, Medical Termination Date (Days Since), Medical Election, Dental Election, Vision Election, Type, Relationship, Coverage Tier, Grouping, Partial assessment completed, is Enrolled Spouse, has Enrolled Spouse, Registered, Periodic Email Summary, Has Email Address, Opt In Challenge Communications, Has Phone (Home or Mobile or Other), Has Phone (Preferred), Has Address.

Health statistic data elements are values that may be associated with a client user's health status and may include, for example: Triglycerides, Fasting Glucose, Resting Pulse, HDL Cholesterol, Total cholesterol, Height, Weight, Body Mass Index, Blood Pressure (systolic), Non-Fasting Glucose, Waist Circumference, Blood Pressure (diastolic), LDL Cholesterol.

Gap in care data elements may be automatically identified indicators that an intervention designed to improve or maintain the member's health may be warranted. Such gaps may be inferred based on past claim history, and may be referred to using standardized or proprietary codes or identifiers—for example, Acme code A12345, corresponding to “Missed A1C test for diabetic.” In certain embodiments, gaps in care may be considered protected health information. Gaps in care may include, for example: members without specified prescription refills during a specified period of time; members without a specified type of office visit during a specified period of time; or members without a specified diagnostic test during a specified period of time. Gaps in care may be identified from a patient's insurance claim records. The specified period of time may be, for example, one, two, three, four, five, six, or 12 months, or 18 months, or one year. Specified types of office visits may be, for example, a reference to a visit with a type of practitioner or practice (e.g., psychologist, hospitalization, or dialysis visit), or may refer to the length of the office visit (e.g., long, short). Specified diagnostic tests may be, for example, a colorectal cancer screening, mammogram, or an HbA1c test. Specified prescription refills may be, for example, a category of drug, such as ACE inhibitors or antihypertensive drugs, or an individual drug, such as Zoloft® (sertraline).

In certain embodiments, groups of care gaps may be associated with a care gap group identifier, for example, a particular provider or source, such that certain rules may be configured to involve only a specified group of care gaps associated with a particular group identifier. For example, a particular group of care gaps may be configured to apply to a subset of a population of members using for example, population rule options 1010 and a care gap group identifier.

Health risk data elements are values that may be associated with a client user's current health status or predicted future status. For example, the risks may be calculated from, e.g., health statistics for a member/client user, and may correspond to percentages or likelihoods of a member's risk for developing a disease. In certain embodiments, health risks may be a binary status, referencing a presence or absence of a disease or condition. Health risks may include, for example: Diabetes, Breast Cancer, Prostate Cancer, Colon Cancer, Congestive Heart Failure, Chronic Lung Disease, Coronary Artery Disease, Angina, Asthma, Stroke, Cardiovascular Disease, Back Pain.

Health assessment answer data elements are numeric or textual values corresponding to responses provided by the client user in response to health assessment questions. Health assessment answers may include, for example, responses to: What is your weight?, What is your height?, What is your waist circumference?, What is your systolic blood pressure (high number)?, What is your diastolic blood pressure (low number)?, What is your total cholesterol level?, What is your HDL cholesterol level?, What is your LDL cholesterol level?, What is your triglyceride level?, What is your fasting glucose?, What is your non-fasting glucose?, What is your resting heart rate?, Which of the following do you consider your race/ethnicity?, On average, how many hours a week do you spend doing vigorous exercise?, On most days, how many cups of vegetables do you eat?, Do you currently smoke cigarettes?, How many years have you smoked?, How many cigarettes do you usually smoke per day?, Have you smoked at least 100 cigarettes in your ENTIRE life?, During the past 4 weeks, how often have you felt short of breath?, Do you ever cough up mucus or phlegm?, Do you feel you are less active in the past 12 months due to . . . ?, Have you had a sigmoidoscopy or colonoscopy in the past 10 years?, In the past 30 days, have you taken medications containing a . . . ?, In the past 30 days, have you taken medications that do not . . . ?, Has your doctor told you that you have left ventricular hypertrophy?, Have you had a history of atrial fibrillation?, Are you currently taking medication for blood pressure?, Do you have a medical history of any breast cancer?, How old were you when you had your first period?, How old were you when you had your first live birth of a child?, Do you still have your periods?, If you no longer have periods, when was your last period?, Have you in the past 2 years used estrogen supplementation?, Have you ever had a breast biopsy?, Have you ever had a breast biopsy with atypical hyperplasia?, Select appropriate answer regarding pregnancy (optional), Have you ever had a Prostate Specific Antigen (PSA) test?, If you have had a PSA test, what was your score?, The last time you had a digital rectal exam (ORE), . . . ?, Have you ever had a prostate biopsy?, Angina?, Asthma?, Back Pain?, Breast Cancer?, Cardiovascular Disease?, Chronic Obstructive Pulmonary Disease (COPD)?, Colon Cancer?, Congestive Heart Failure?, Coronary Artery Disease?, Depression?, Diabetes?, Heart Valve Disease?, Heart Attack?, Kidney Disease?, Prostate Cancer?, Osteoarthritis?, Stroke?, How often do you feel tense or anxious?, During the past year, has stress affected your health?

Incentive data elements may be a category of values that may be associated with the status of a particular incentive—e.g., indicating that a client user is eligible, has completed, submission was denied, reward was paid, user is ineligible, task is provisionally completed, or task is not applicable. Such values may apply to particular incentives (i.e., the data element) such as a health assessment questionnaire.

Reimbursement data elements may be a category of values for associating items (e.g., receipts) submitted for reimbursement with each user, where the items may have values of eligible, approved, and rejected.

Message configuration sequence data elements may include any configured message (i.e., the data element), where the values associated with each message for each client user may be delivered, recalled, deleted, or read.

Quiz data elements may be used to associate the status of a quiz with each user, such that the value for a particular quiz may be not started, started, passed, or failed. Quizzes may include, for example: High Cholesterol Quiz, Diabetes Quiz, Breast Cancer Quiz, Weight Management Quiz, Colon Cancer Quiz, Tobacco Cessation Quiz, High Blood Sugar Quiz, High Blood Pressure Quiz.

Activity plan level data elements may be used to associate each user with a current activity plan level. (E.g., a particular activity plan level data element may be used to identify all users who have reached a particular level in a given benefit year's activity plan.)

In certain embodiments, the system may allow the administrator user to test a particular configuration of population rule options in order to evaluate the number of users associated with each targeted population prior to executing the associated action (e.g., delivering the message, as shown in user interface 1000 and as provided by the population rule option 1010 feature of “test rules”).

Exemplary administrator user interface 1000 additionally includes options to configure a sequence message 1012. In certain embodiments, the system may be configured to automatically prepare and deliver a follow-up communication, such as a sequence message to client users following the first message. For example, sequence messages may be used to send one or more reminders if an appropriate response is not registered with respect to the initial message, or to provide information that is relevant at time later than the initial message. As one example, a message may be configured to be sent to a client user when a care gap is opened for that user. Sequence messages may be associated to this message to remind the user to address the care gap after 30 and 60 days.

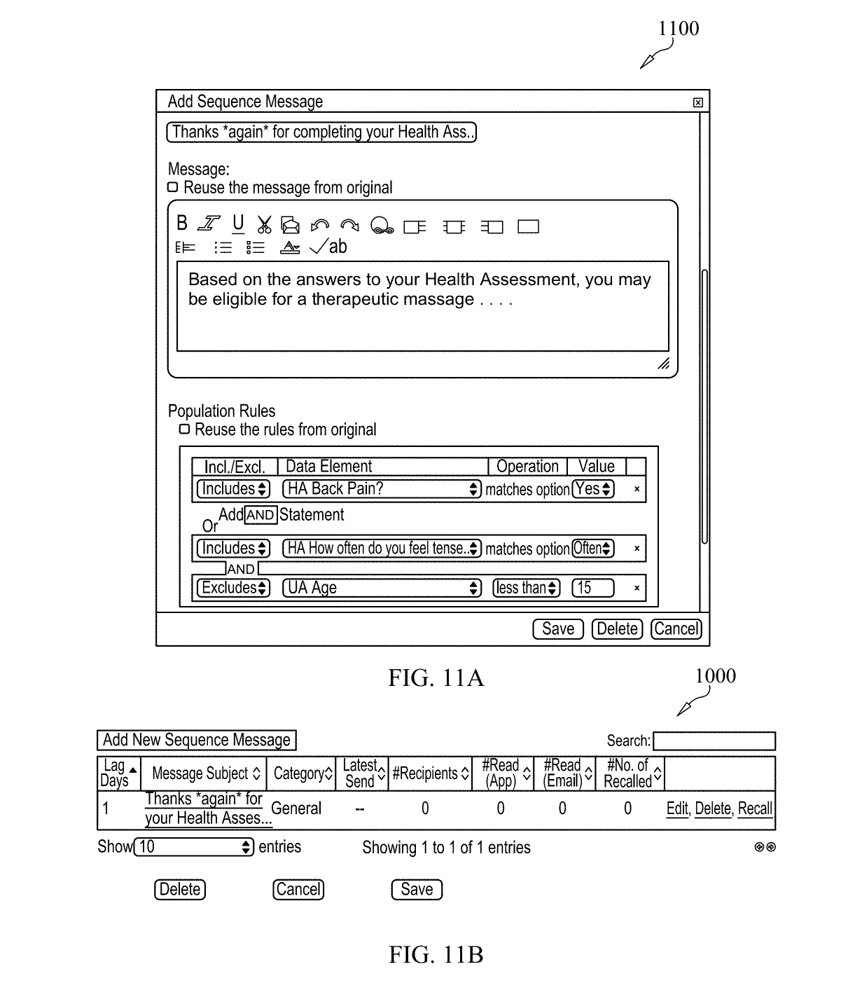

FIG. 11A-B shows exemplary administrator user interface 1100 for configuring a sequence message. Upon selecting the “Add New Sequence Message” control in options to configure a sequence message 1012 of user interface 1000, the user may be presented with user interface 1100. As shown in FIG. 11A, the user may, for example, reuse the content from the original “parent” message (e.g., in the case of a reminder regarding an unread initial message), or may provide customized content. The user may additionally target the same population as configured using population rule options 1010 with respect to the parent message, or the user may configure the population rule options differently as applied to the sequence message, as shown in exemplary FIG. 11A, to select a sub-population of the client users targeted with the parent message. (In the exemplary configuration shown in FIG. 11B, the parent message is configured to be sent to all users who have completed a health assessment questionnaire. The sequence message shown is configured to be sent to just the subset of users who, in the health assessment, identified themselves as having back pain or users who indicated they often feel tense or anxious and are not less than the age of 15.) In certain embodiments, additional configuration features may be available in addition to those in population rule options 1010, such as whether the parent message was viewed or read by the client user via an app using message center user interface 304 or via an email, or whether the parent message was recalled. In certain embodiments, user interface 1100 provides an option to set the number of lag days after the sending of the parent message that the sequence message should be evaluated; if a client user is still eligible to receive the message upon evaluation, the sequence message will be sent. In certain embodiments, the parent message is “hidden” so that only sequence messages are sent to users, and the “hidden” parent message is merely configured to toll the counting of lag days. Upon submitting the configured sequence message, user interface 1000 is updated to show information about the new sequence message, as shown in FIG. 11B. In certain embodiments, the system indicates information about each configured message and sequence message, such as when they were sent, how many client users received them, how many client users have read the messages, and how many messages have been recalled.

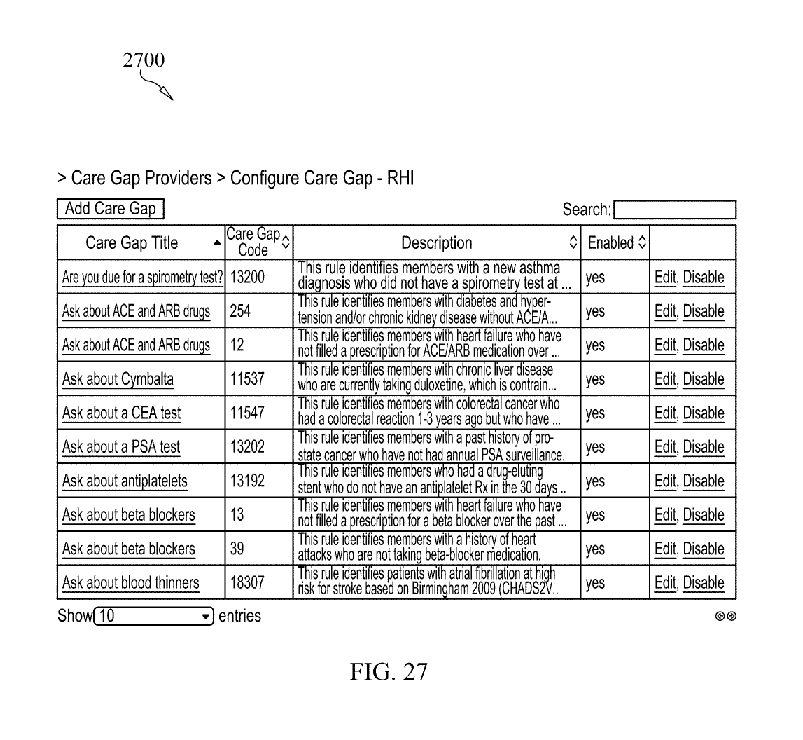

FIG. 27 shows an exemplary administrator user interface 2700 for configuring communications regarding care gaps, for example a group of care gaps associated with a care gap group identifier that is a particular provider, such as an insurance provider. In this example, handling for individual care gaps can be disabled, new care gaps can be added, and existing care gaps can be edited.

In certain embodiments, where a care gap exists for a member, the member may be prompted to take action based on the care gap. For example, a client user with access to the member's account may be presented with a prompt upon login—for example, the client user may be instructed to respond to a prompt requesting the client user to talk to a doctor about the missing test or prescription associated with the care gap, or to affirm that the test was recently performed, or the like.

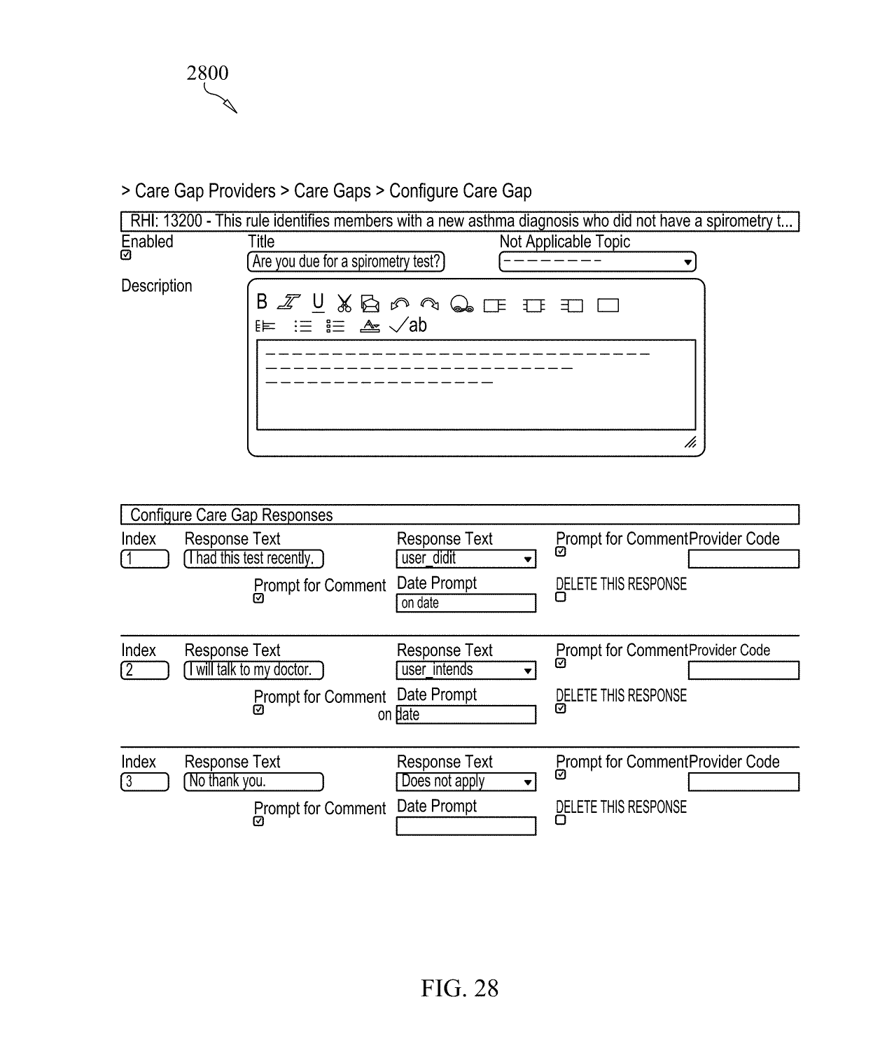

FIG. 28 shows an exemplary administrator user interface 2800 for configuring individual care gaps—e.g., user interface 2800 may be used to configure the description or content of the message conveying the care gap to the client user (e.g., using controls available as described with respect to content editor 1006), and a response-input element—e.g., the answers a user can provide for a prompt in response to determining or receiving information about a particular care gap. In some examples, the care gap may be configured such that user may be requested to provide additional comments about the provided answer (e.g., comments on the client user's selected “response text” in user interface 2800). In certain embodiments, a response-input element may be configured to directly receive input from the client user—that is, the response-input element includes user input elements such as drop down boxes, check boxes, text fields, or radio buttons that receive user input via the same user interface that is used to display the care gap message/information, such as the configuration options shown under “Configure Care Gap Responses” in user interface 2800 (and in contrast to indirectly receiving input, such as by requesting that the client user make a phone call to a specified number or providing an email address for receiving the client user response). In certain embodiments, such a care gap administrator user interface may be used to configure a particular care gap template customized for a particular care gap type. A care gap type be referenced using a group identifier or a care gap identifier that can be used to describe a collection of care gaps each associated with a client user that have some common aspect, such as an insurance provider, employer, or medical issue.

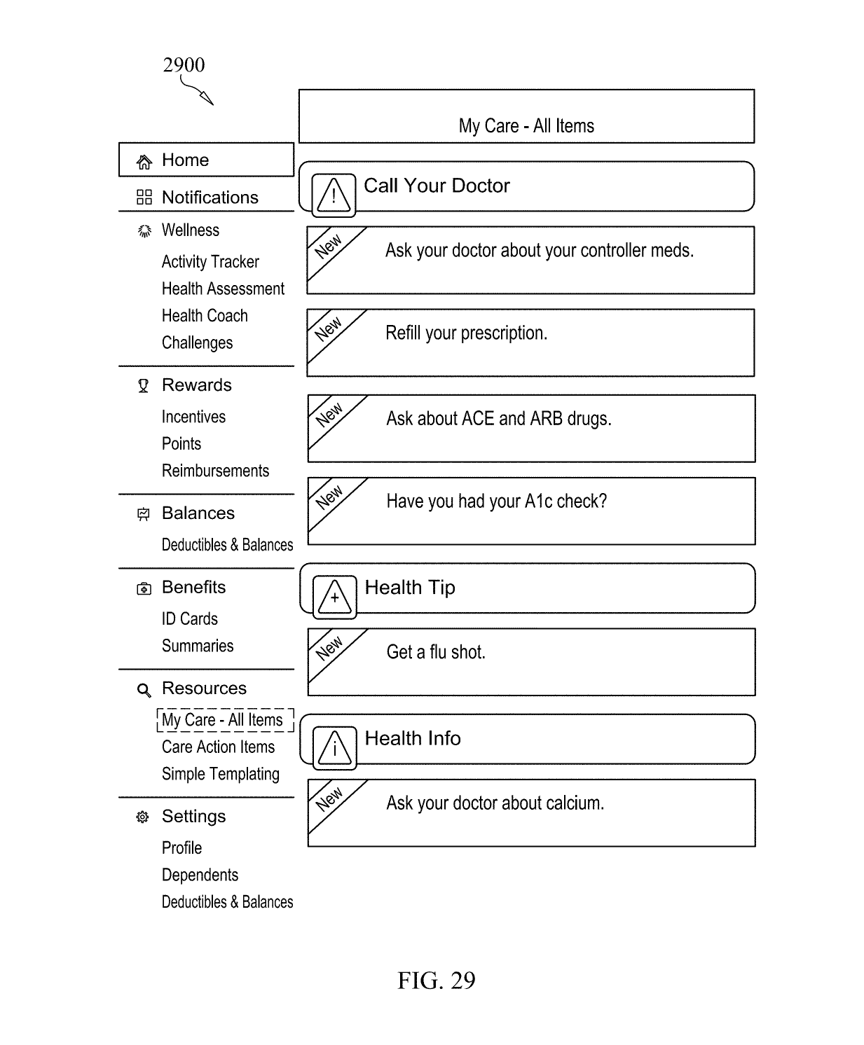

FIG. 29 shows an exemplary client user interface 2900 displaying a resource module providing access to a care gap dashboard providing access to personalized care information concerning care gaps (“My Care” resource). User interface 2900 displays an alert message based on one or more identified care gaps for the client user (with text instructing the user to “Call Your Doctor”). The exemplary client user interface provides various categories of selectable elements corresponding to instructions to address various care gaps associated with the client user/member (e.g., items necessitating a communication with a doctor (“Call Your Doctor” category) such as “Ask your doctor about your controller meds,” “Refill your prescription,” and “Ask about ACE and ARB drugs”; suggestions or items that may involve over-the-counter care (“Health Tip” category), such as “Get a flu shot”; and other instructions regarding actions that may lead to addressing a care gap (“Health Info” category)). User interface 2900 represents a real-time indication of the current state of any care gaps associated with the client user/member—for example, if a care gap is determined to be closed, it will no longer appear as a selectable element in the listing of selectable elements corresponding to care gaps, regardless of whether or not the client user has selected the element or viewed the associated care gap. In certain embodiments, the categories are arranged according to the priority of the care gap, such as by decreasing priority. In certain embodiments, each care gap is associated with a category attribute, and each category is associated with a priority, such that the care gaps can easily be presented in the client-user interface ranked by priority so that the most important care gaps may be addressed first. Selecting any of the selectable elements will cause the client user to be presented with a client user interface including a response-input element, such as user interface 3000—e.g., requesting an action from the client user, such as a confirmation that the member has already addressed the issue and the instruction to address the care gap is moot, or confirmation that the client user/member will follow up on the instruction, for example by a certain date. In certain embodiments, the resource module of user interface 2900 may be accessed separately from a notifications/message center, as shown in FIG. 29.

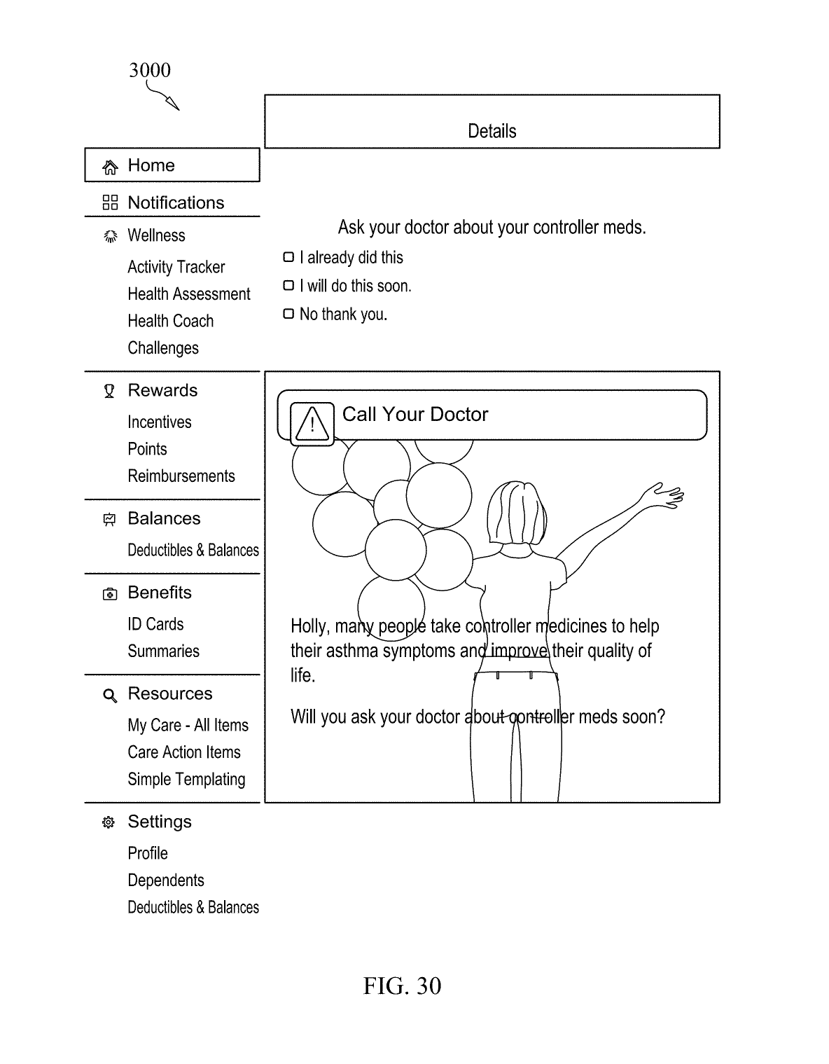

FIG. 30 shows an exemplary client user interface 3000 that might appear upon selecting a care gap notification in a message center—e.g., upon selecting the element labeled “Ask your doctor about your controller meds” in user interface 2900. User interface 3000 displays a response-input element for directly receiving response input via the same user interface from the client user—e.g., a set of specific user actions (e.g., tasks) that the client user can choose or agree to perform regarding an identified care gap. In the example shown in FIG. 30, the options are to select one of: (1) “I already did this,” (2) “I will do this soon,” and (3) “No thank you.” In certain embodiments, selecting a particular option may trigger a prompt for additional information—e.g., selecting options (1) or (2) may result in a request for client user to select or otherwise provide the date on which the action was taken or will be taken, or the user may be presented with a text field to provide comments on the task or instruction.

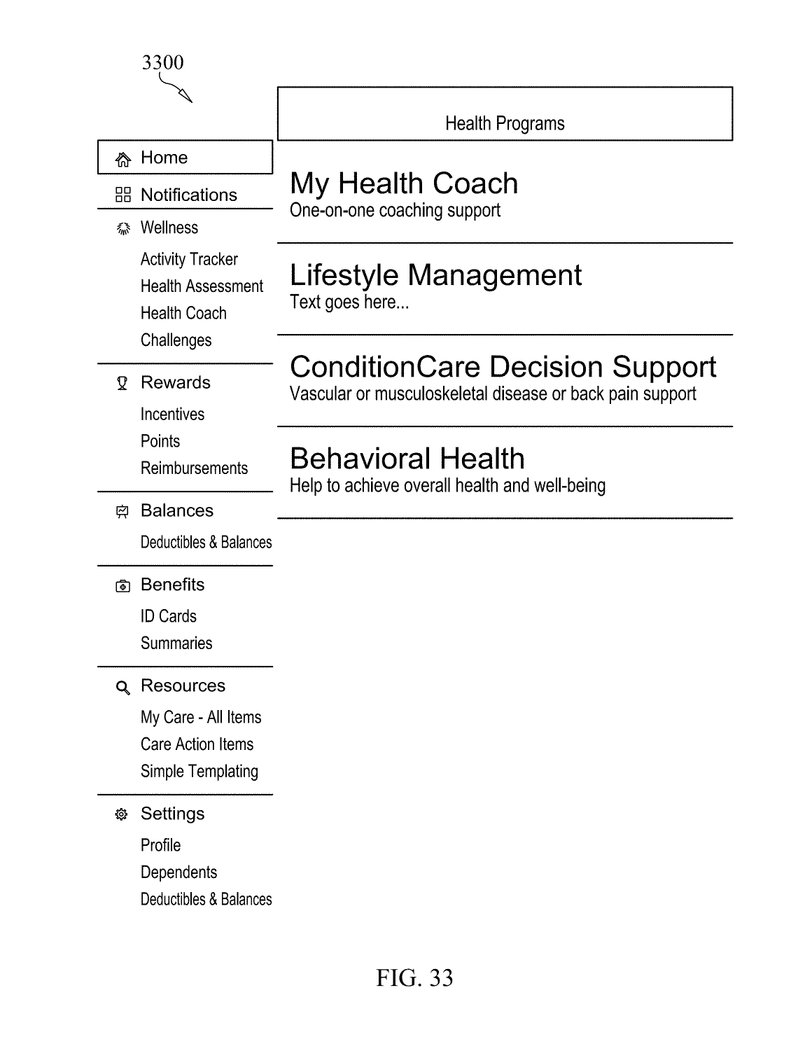

FIG. 33 shows an exemplary dashboard client user interface 3300 for available health management programs. User interface 3300 may list selectable elements for accessing various interactive health management programs, such as a health coach (see, e.g., FIG. 8A-D), lifestyle management, support for particular health issues such as back pain or vascular disease (if applicable to the client user), and behavioral health. In certain embodiments, such a dashboard may provide access to a care gap dashboard (e.g., user interface 2900) or a care goal dashboard (e.g., user interface 3400) via a selectable element within the list of interactive health management programs.

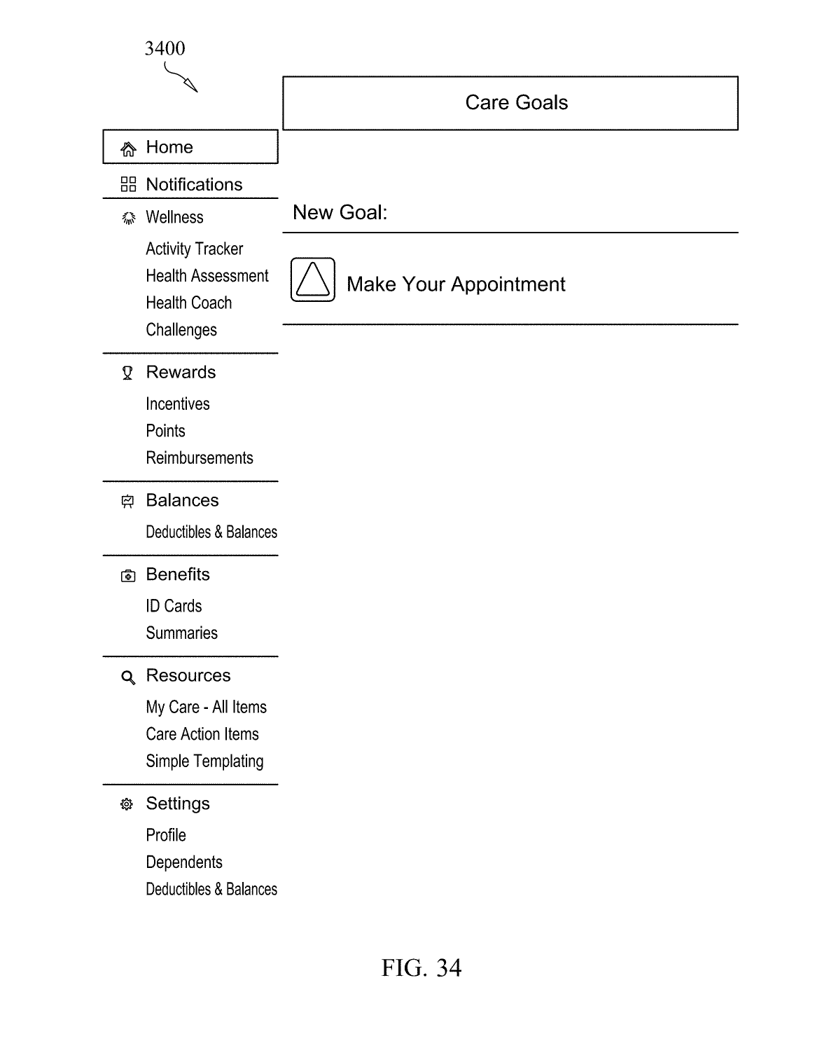

FIG. 34 shows an exemplary dashboard client user interface 3400 for a care goal resource module. Such an interface may be used to list available care goals for a client user/member. A “care goal”, as used herein, refers to a health-related goal target that the client user/member may take steps to achieve or satisfy, and that is typically not satisfied when the care goal is originally created. In certain embodiments, addressing a care gap (i.e., remedying the care gap) may be considered a specific type of care goal. As shown in FIG. 34, user interface 3400 lists a single available care goal. User interface 3400 may be used to list any number of available care goals. In certain embodiments, a universe of potential care goals can be pre-configured, and the subset of care goals that are applicable to the client user/member and are active are presented in the dashboard user interface 3400. In certain embodiments, care goals are associated with care goal categories (e.g., new care goals, top care goals, minor care goals, exercise goals, diet goals). In certain embodiments, the care goal categories are arranged according to the priority of the care gap, such as by decreasing priority. In certain embodiments, each care goals is associated with a care goal category attribute, and each category is associated with a priority, such that the care goals can easily be presented in the client-user interface ranked by priority so that the most important care goals may be addressed first. By selecting a selectable element in the list (e.g., selecting “Make Your Appointment” listed under “New Goal”), a client user may create a new care goal or access an existing care goal. In certain embodiments, upon selecting an option to create a new care goal, the client user may be prompted to configure a care goal by entering parameters such as the type of care goal, the requirements or metric for satisfying the care goal, and/or a planned completion date for satisfying the care goal. In certain embodiments, upon selecting an option to create a new care goal, the client may be prompted to contact an administrator, and the administrator may identify applicable care goals and configure one or more care goals for the client user. In certain embodiments, configuration information for care goals may be imported for one or more client users from a file or URL. A care goal may additionally be automatically generated through an interactive health management program, such as an interaction with a health coach (see, e.g., FIG. 8A-D). Such a program may, through the answer to a question or by accessing claims-related information or other health-related information for the member, determine that a particular care goal is appropriate. For example, a client user may navigate to a user interface indicating that the associated member's triglycerides are too high or in a range associated with a health risk (FIG. 8B); in certain embodiments, under the section “What can I do about it”, the user interface may present a control to activate a related care goal (e.g., a goal to “lower your triglycerides by next year”). In certain embodiments, the related care goal may automatically be activated without presenting a UI option within the health coach. Care goals may be associated with a care goal type—for example, the type may be a weight loss goal, an exercise frequency goal, or a care gap type if the care goal is a care gap.

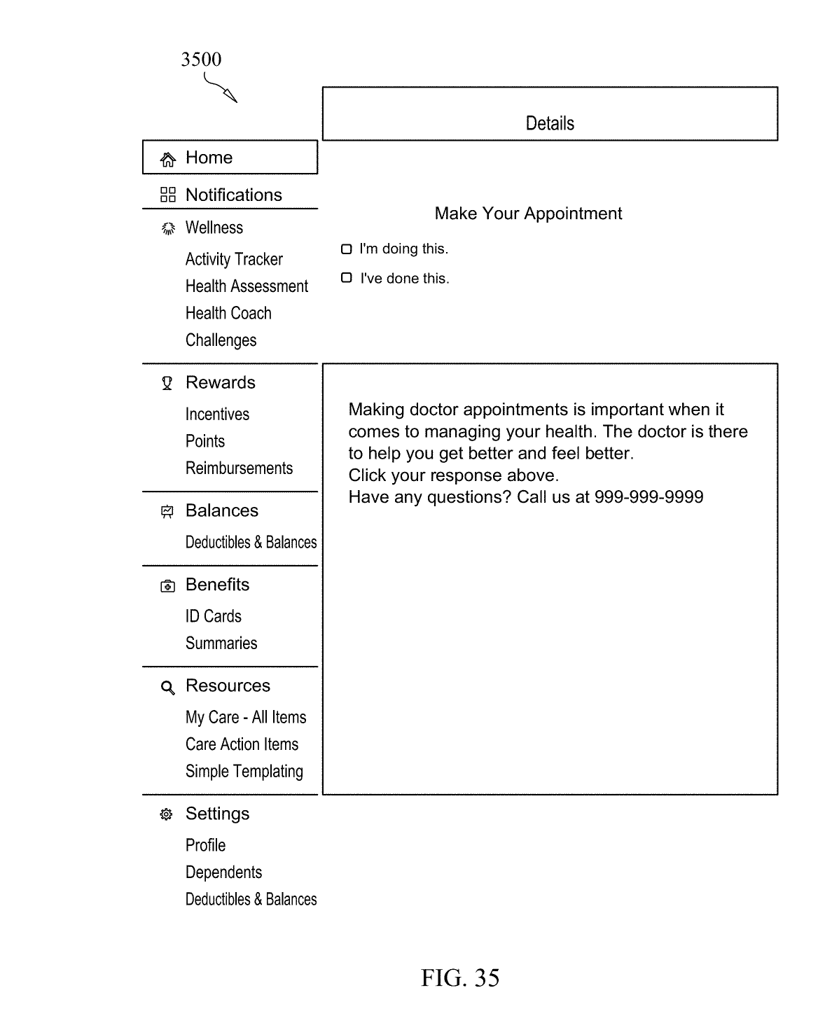

FIG. 35 shows an exemplary client user interface 3500 concerning a care goal, e.g., that might appear upon selecting a care goal notification in a message center or a prompt presented to a client user. User interface 3500 displays a response-input element for directly receiving response input via the same user interface from the client user—e.g., a set of specific user actions (e.g., tasks) that the client user can choose or agree to perform regarding an identified care goal. In the example shown in FIG. 35, the options are to select one of: (1) “I'm doing this,” (2) “I've done this.” In certain embodiments, selecting a particular option may trigger a prompt for additional information—e.g., selecting option (2) may result in a request for client user to select or otherwise provide the date on which the action was taken, or the user may be presented with a text field to provide comments on the task or instruction.

In certain embodiments, client user interfaces similar to 2900 and 3000 may be used to encourage a member to address any automatically identified circumstance representing a correctable health issue or opportunity to improve the health of the member, particularly where that circumstance or opportunity may be associated with a related user action/task for the client user/member. For example, correctable health issues may include care gaps, an unusual drop in physical activity as measured by an activity tracker, or a lack of a vaccination, such as an annual flu vaccine. Opportunities may include, for example, eligibility to participate in a fitness challenge or an individual goal such as completing 30 minutes of exercise for one or more consecutive days. A requested user action may include asking a doctor or health care provider for assistance in correcting a health issue, or taking an over-the-counter action (i.e., an action that does not require permission of a doctor) such as obtaining a flu shot, increasing exercise, taking an over-the-counter drug, or changing a sleeping schedule. By requesting confirmation or a commitment from the client user, the service may encourage an improvement in follow-through from the client user as compared to simply providing information about the circumstance or opportunity. In certain embodiments, the service may follow up with the client user via an automated communication (e.g., a message or email) at a set interval or based on a deadline set by the client user as part of the response from the user to the initial request, for example to verify whether a task was completed or to remind the user about the user's promise where the task remains uncompleted.

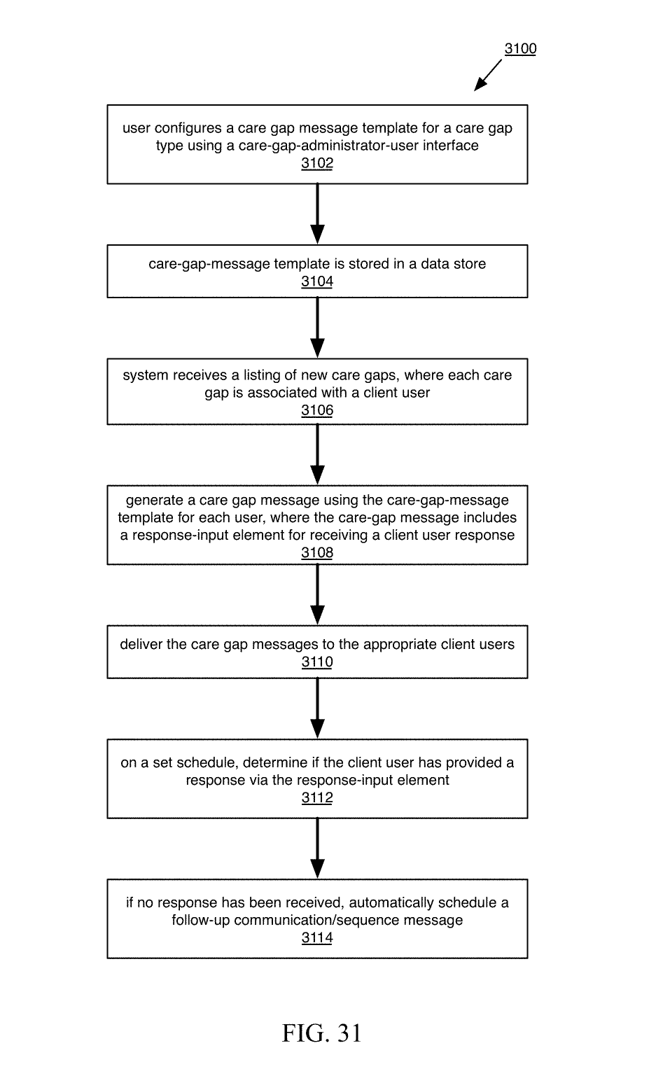

FIG. 31 is a flow chart depicting an exemplary process 3100 for facilitating client user responses to care gaps. An administrator user may configure or save settings defining a care gap message for a care gap type using, for example, care gap administrator user interfaces 2700 and 2800 (step 3102). For example, each of the exemplary items associated with a separate care gap code listed in user interface 2700 may reference a care-gap-type-message template, each having a care gap type corresponding to the care gap code. A user may save a particular care-gap-type-message template to a data store using, for example, user interface 2800 (step 3104). In certain embodiments, such a care-gap-type message template may be configured as part of a care-gap-type object with additional attributes such as a care-gap-type description and conditions for when the associated message and other messages should be sent to an appropriate client user. Polling care gap information may include receiving a file of user identifiers and care gap information in real time, e.g. as care gaps arise (e.g., by receiving a notification and accessing a file or data stream at a uniform resource locator on a network), or it may include executing a sequence of instructions to determine or retrieve care gaps on a regular basis (step 3106). In certain embodiments, upon receiving new care gap information, an instance of a care-gap-type object is created for each separate care gap. A care gap message generated using the care-gap-type-message template may be generated that incorporates a response-input element by automatically replacing variables or placeholders in the template as configured with values that are associated with the particular client user (e.g., client attributes sourced from a data store), or other variable values as appropriate, e.g. in accordance with conditional templating or variable placeholders (step 3108). In certain embodiments, a care-gap message may be generated and sent on a regular schedule—for example, each month, each client-user may be notified of all open care gaps associated with the client user. In certain embodiments, a message may relate to one or more types of care gaps. In certain embodiments, the creation of the care gap message is paired with notifications via email and changes to the information that a client user sees upon logging in to a client user landing page to alert the client user to the availability of the message. In certain embodiments, the message may be generated automatically upon receipt of the care gap information, or it may be scheduled to be generated, e.g., when additional information is available. The care gap message is delivered by being made available for viewing to the client user (step 3110). In certain embodiments, the care gap message is stored solely in a data store managed by the system. In certain embodiments, a care gap message may also be stored locally at a client device, e.g., within application data stored at the client device. In certain embodiments, the care gap message may be configured to be delivered upon occurrence of a trigger event. After delivery of the care gap message, the system may be configured to regularly check whether a response has been received via the response-input element (step 3112). In certain embodiments, a client user's response to a response-input element may be saved as a client-user attribute. After a set period of time after delivery of the care gap message, or upon the occurrence of a trigger event, the system may deliver a follow-up communication (step 3114). In certain embodiments, such a trigger event may include the client-user entering a response via the response-input element. The follow-up communication may be configured using a sequence message administrator user interface including components shown in user interface 1100. For example, a follow-up communication may remind the client user to respond to the care-gap message by presenting a response-input element, or the communication may thank or congratulate the client user for providing a response if a response was provided. Additional follow-up communications may be scheduled for delivery, e.g., until a response is received or the care gap is determined to be closed.

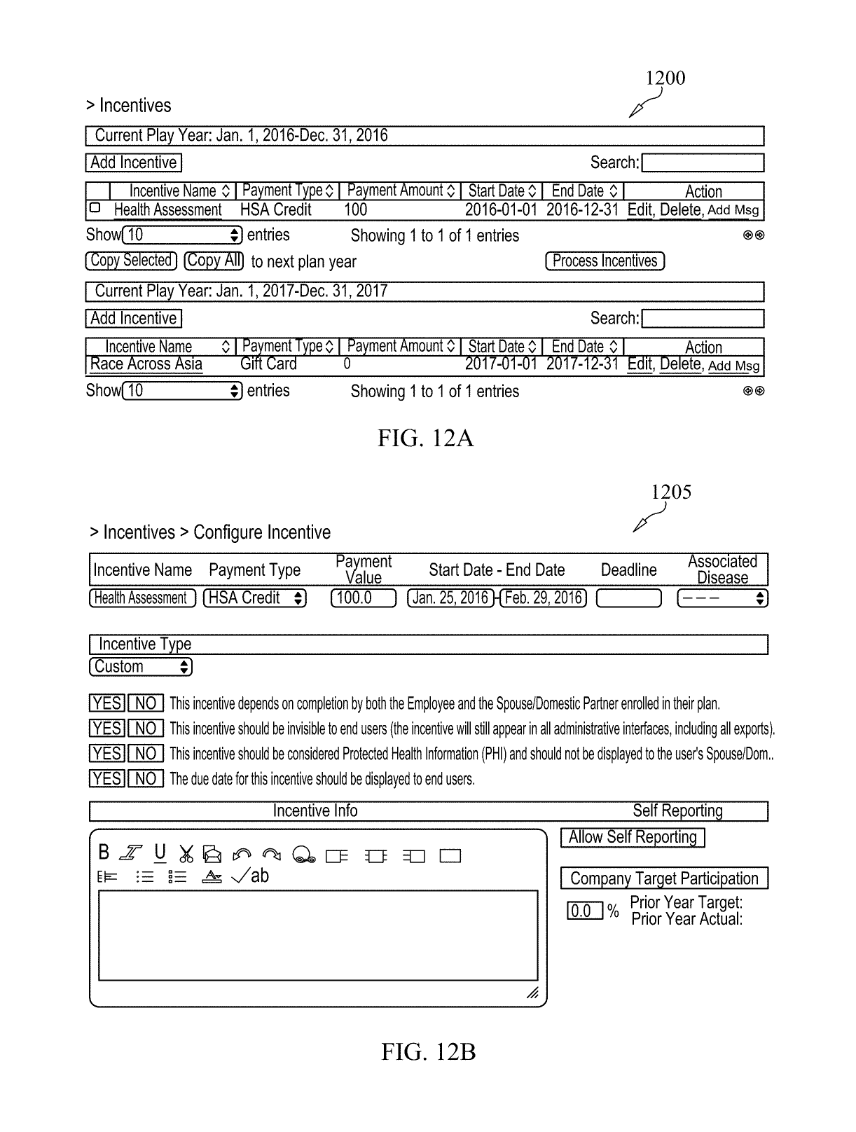

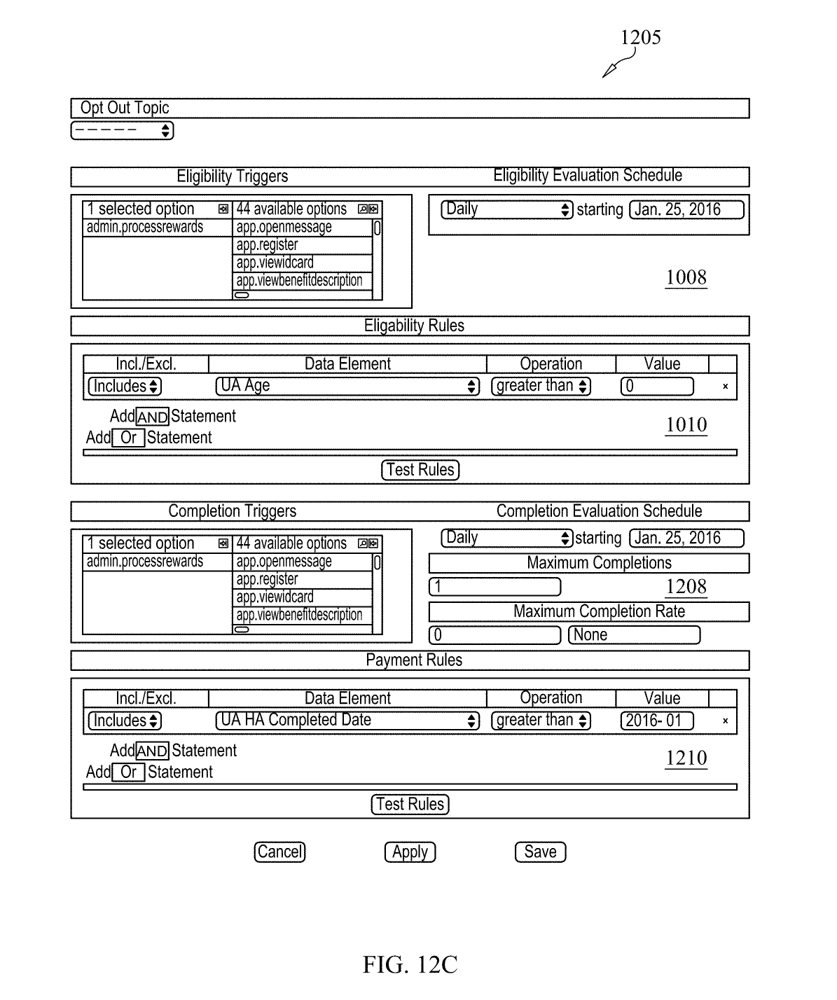

FIG. 12A-C shows two exemplary administrator user interfaces 1200 and 1205 for configuring incentives. FIG. 12A shows an exemplary user interface 1200 showing an overview of two exemplary configured incentives, organized according to the time periods (plan years) during which they may be activated (i.e., the active periods for each incentive). Each incentive is configured to define a reward and the task which must be completed in order to receive the award. In the two incentives shown in user interface 1200, the first (“Health Assessment”) is associated with a payment of $100 applied as a Health Savings Account (HAS) account credit upon completion of a Health Assessment-related task. The second incentive is associated with a reward payment in the form of a gift card (value: $0), in relation to completion of a “Race Across Asia” task. User interface 1200 provides controls for editing each incentive, and for accessing a user interface for configuring a message associated with each incentive. In certain embodiments, selecting an “Add Msg” control will present the administrator user with a message configuration user interface such as 1000 wherein the population rule options 1010 are preconfigured to select the client users who are eligible for the incentive, or who are already registered as participating in the incentive; such an interface will permit an administrator user to create or edit a version of incentive message template content for inclusion in the incentive program.

FIG. 12B shows the top portion of exemplary user interface 1205 for configuring an incentive. As shown, user interface 1205 provides configuration options to set the payment type or reward for the incentive, a period during which the incentive is available, and parameters such as whether to permit client users to submit their own progress with respect to the task, and the goal for the percentage of the total client user population for an organization who will participate in the incentive.

FIG. 12C shows the bottom portion of exemplary user interface 1205 for configuring an incentive. As shown, a client user's eligibility for participating in the incentive may be triggered by eligibility trigger event rules including an eligibility trigger event using eligibility options 1008, which may be configured as discussed with respect to user interface 1000. A client user's eligibility for participating in the incentive may additionally be configured based on whether the client user is a member of a particular population using eligibility-population-rule controls such as population rule options 1010 (e.g., all users with a user age attribute greater than 0, as shown in user interface 1205). Such population rule options may be configured as discussed with respect to user interface 1000. The system may be configured with completion-trigger-event rules to automatically determine when a client user has completed the task which must be completed in order to receive the incentive award. As shown in FIG. 12C, this determination may be based on a trigger event—e.g., an event based on the client user's interaction with the system. For example, a health assessment questionnaire incentive may be determined to be complete when the system has determined that it has received all answers to the questionnaire (e.g., function or attribute “healthassessment.complete” evaluates as “true”). In certain embodiments, the completion trigger may be set to simply always be satisfied and cause processing of a payment on a set schedule, based on whether the payment or reward rules indicate that a reward is due. Additionally, the system may be configured to limit the number of times a particular client user may participate in the incentive (and receive an award). Such features may be configured using completion options 1208. Additionally, in certain embodiments, payment of the award may be configured with reward rules using population rules options 1210, e.g., to define a population of client users who have all completed the health assessment during a certain date range.

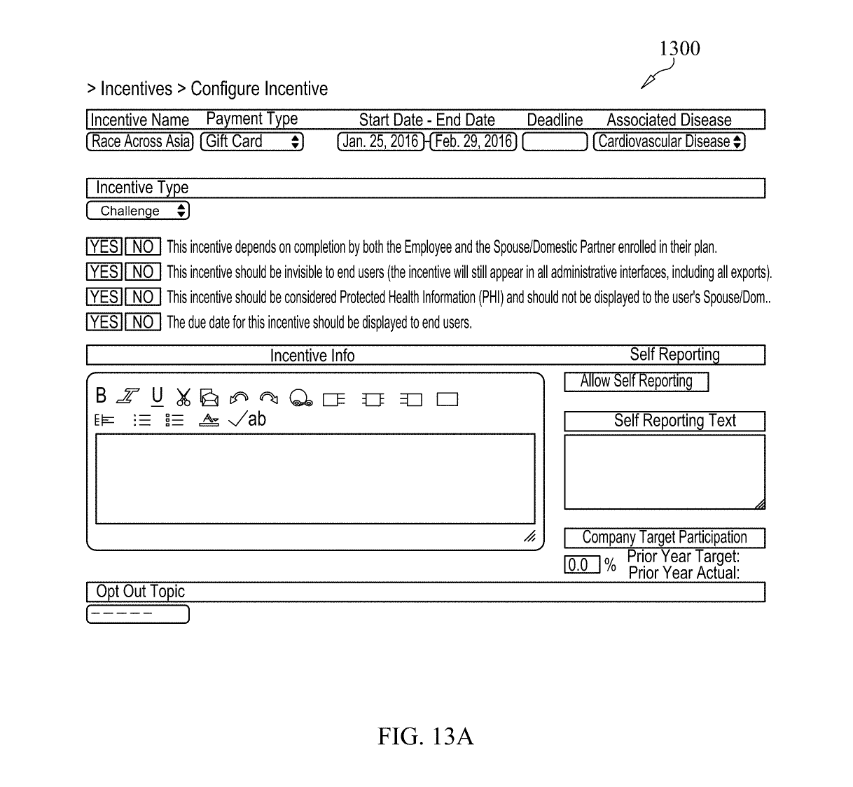

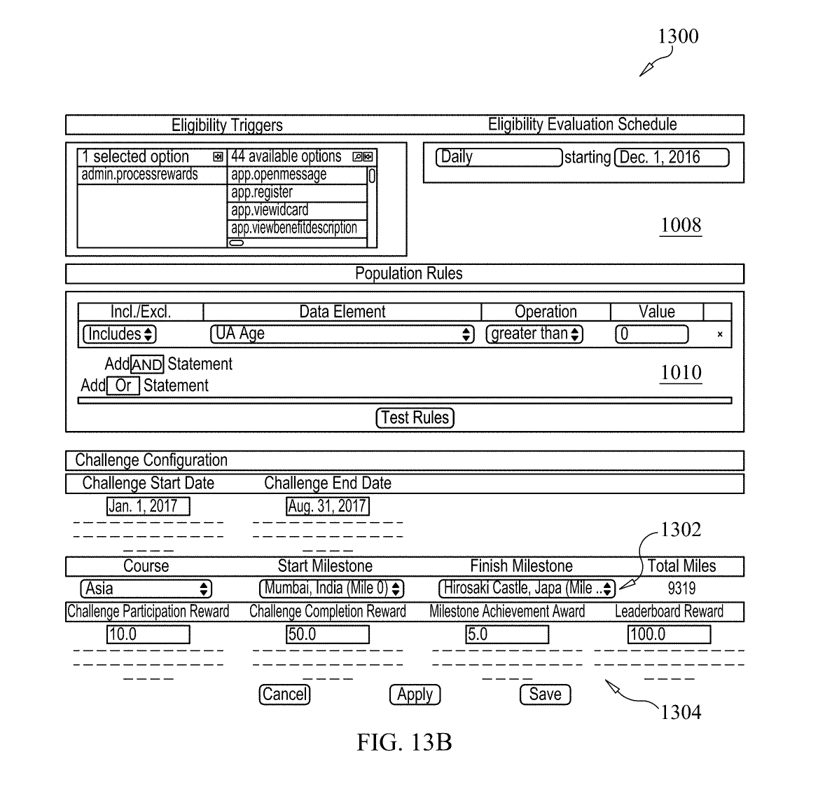

FIG. 13A-B shows an exemplary administrator user interface 1300 for configuring a challenge. A challenge is a particular type of incentive in which certain aspects of the definition of completing the associated task are constrained. As shown in FIG. 13A, a challenge (or an incentive more generally) may be grouped into a category based on a common feature, for example, an associated or targeted disease (“cardiovascular disease” in the “Race Across Asia” incentive shown in user interface 1300). Additionally, for example, awards may be provided in response to completing stages of the task. In certain embodiments, a group of members may contribute together to complete the task. For example, as shown in user interface 1300, which configures a group “step” challenge to walk across Asia, the overall task is to collectively record steps/distance traveled (e.g., using an activity tracker or self reporting) that amount to the distance required to walk across Asia. The course across Asia is divided into milestones (i.e., stages) (see course options 1302 in FIG. 13B). The system may be configured to provide various types of rewards using reward controls 1304 (e.g., setting a participation reward for each client user, a completion reward for all participants upon completion, milestone rewards, and leaderboard rewards for members with the greatest contributions at particular stages of the course, for example upon completion of the course).

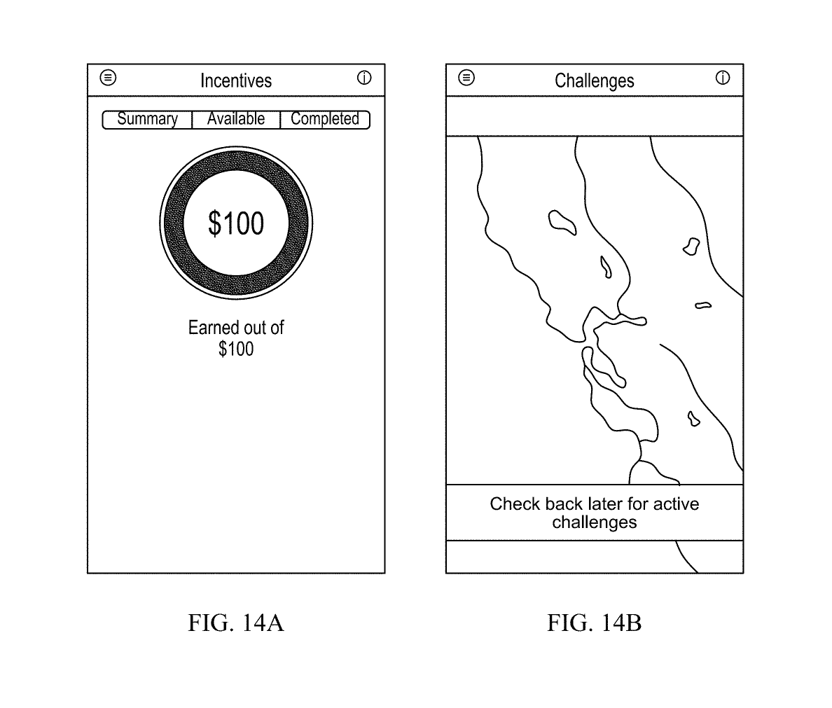

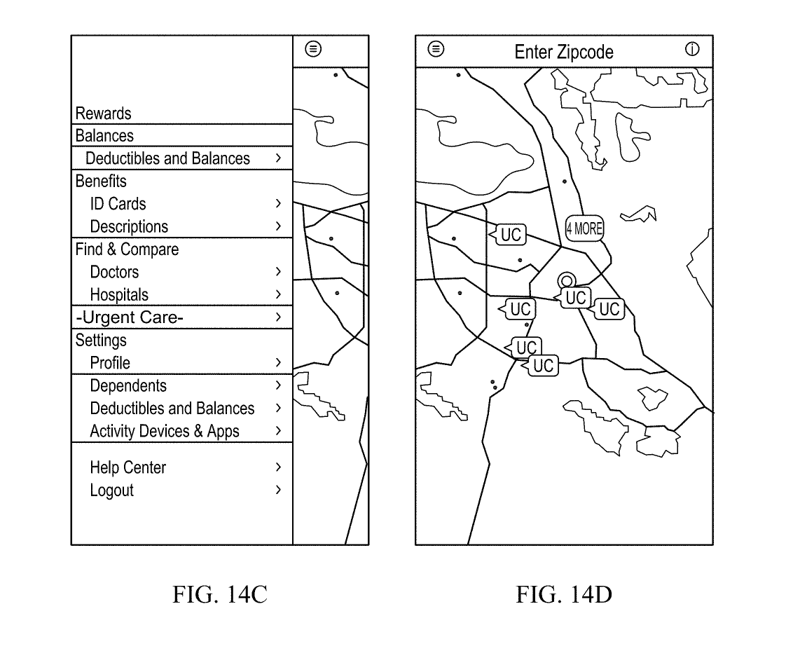

FIG. 14A-D shows four exemplary client user interfaces for embodiments of the system. FIG. 14A shows a graphical depiction comparing the completed and available incentives for a client user. Any incentives associated with rewards having a numeric value (e.g., in points or monetary units) may be represented using such a graphical depiction, providing a client user with a motivation to complete the circle and remain engaged with the wellness program. FIG. 14B shows an exemplary user interface, e.g. for showing the progress of active “walk across X” challenges. For example, if the client user is actively participating in a “Walk Across the USA” challenge, such a user interface could visually depict the progress from the starting point of the challenge (e.g., San Francisco) to the next milestone (e.g., Denver), by plotting a path corresponding to the current distance travelled by the group, and a differently represented path corresponding to the distance remaining to the next milestone. Such paths would be plotted on a map, providing client users with a motivation to complete the path and remain engaged with the wellness challenge. FIG. 14C and 14D show an exemplary client user interface for displaying the locations of nearby urgent care facilities on a map. In certain embodiments, the system may use the location of the client user (for example, as known to the client user's mobile device) to identify the nearest urgent care facilities in relation to the current location of the client user. In certain embodiments, the user interface may be configured to show only facilities that are covered by the client user's health insurance plan. In certain embodiments, the user interface displays doctor offices, dental offices, or hospitals instead of urgent care facilities. In certain embodiments, the doctor offices, dental offices, hospitals, or urgent care facilities may be displayed differently in accordance with an expected reimbursement rate or measure of quality. For example, if the client user is enrolled in a PPO (Preferred Provider Organization) health insurance plan, in-network facilities and doctors may be indicated using a green icon, and out-of-network facilities and doctors may be indicated using a red icon. In certain embodiments, the system provides a user interface for accessing the cost of a particular type of office visit or medical procedure under the member's insurance plan at each nearby hospital, doctor office, dental office, and/or urgent care facility. In certain embodiments, the healthcare provider listings are not limited to nearby facilities, and/or may be grouped by distance and/or geographic region. In certain embodiments, the system may automatically identify or obtain information about a care gap for a client user, and may provide a listing of recommended providers to remedy the care gap ranked by price, distance, and/or quality. In certain embodiments, the system may automatically identify or obtain information about a recommendation for treatment via the health coach for a client user, and may provide a listing of recommended providers to evaluate or execute the treatment ranked by price, distance, and/or quality. In certain embodiments, individual providers may be associated with a suitability related attribute or index for a member based on designations assigned by a particular insurance carrier, quality ratings based on public sources of data, reviews from individuals, and the like. An index may be calculated, for example, using a linear combination of particular client-user and related attribute values. Provider suggestions may be communicated via a message, a notification, and/or a user interface similar to the user interface of FIG. 14D. In certain embodiments, such suggestions will take into account whether or not the client user has an appropriate medical provider to address the identified care gap (e.g., if the existing provider is competent and/or the existing provider's service is optimally priced, this information will be made available to the client user).

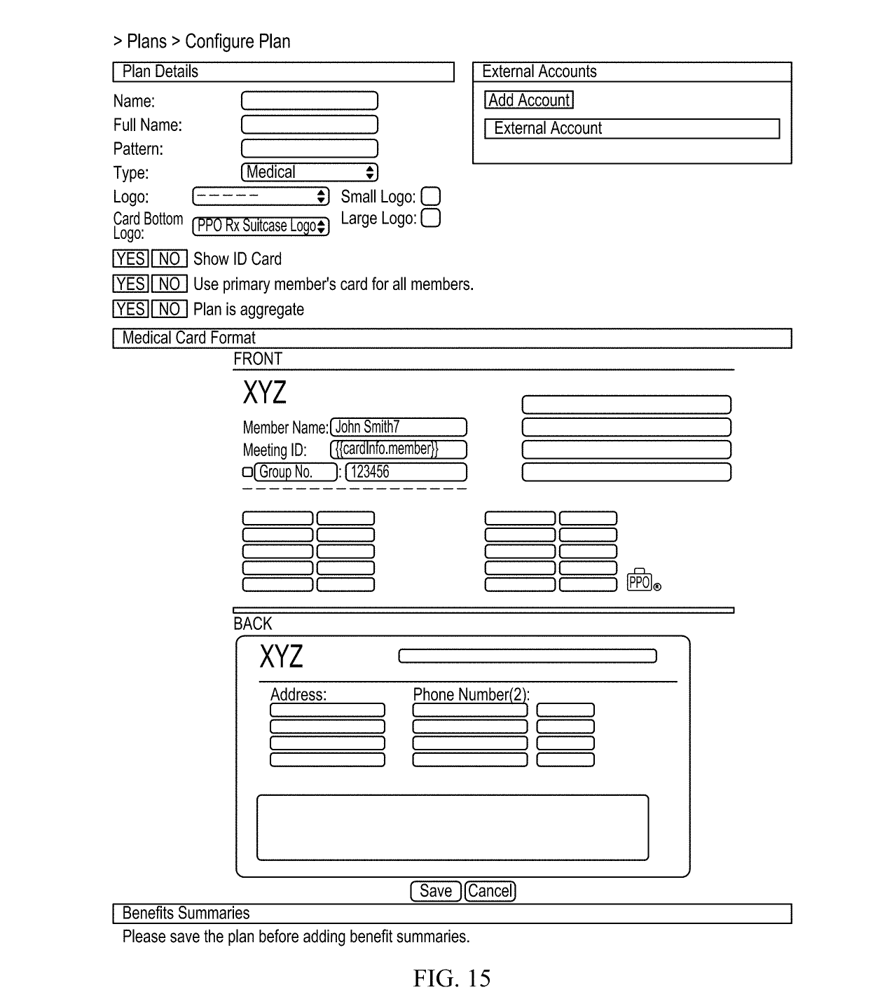

FIG. 15 shows an exemplary administrator user interface for configuring a client insurance ID card; related user interfaces permit configuring a client user interface for providing an insurance plan benefit summary.

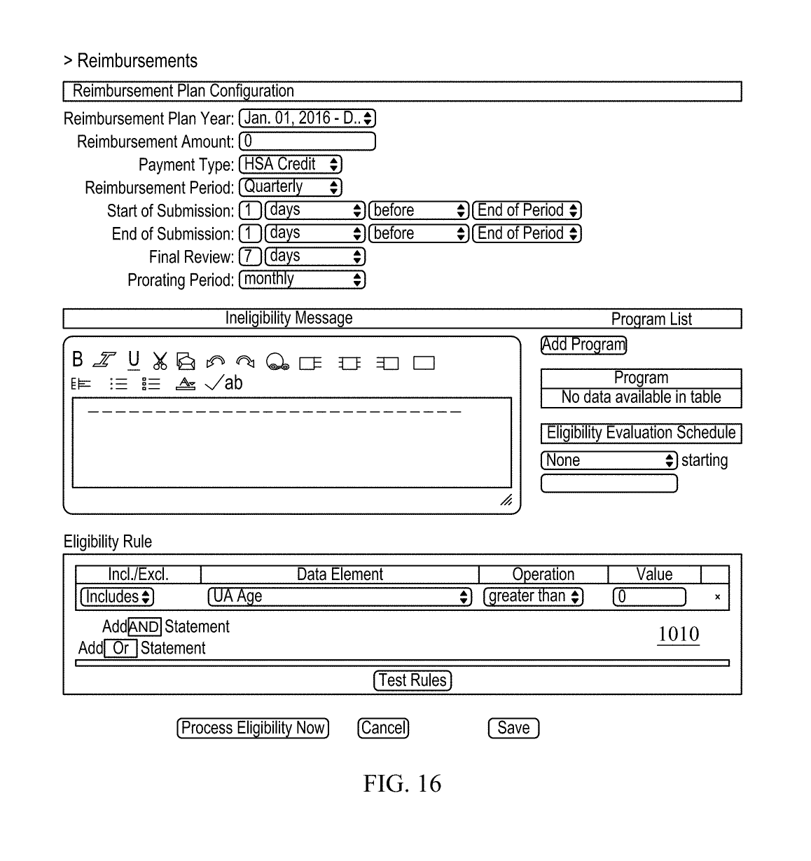

FIG. 16 shows an exemplary administrator user interface for configuring a reimbursement program, e.g., for crediting HSA accounts of eligible client users.

In certain embodiments, the system may securely store a user's credentials for logging into provider for a health insurance or HSA account, and may periodically use those credentials to obtain the current status of the client user's health insurance deductible and HSA account balance. The system may provide a client user interface for viewing the current deductible and/or HSA account balance.

In certain embodiments, the service includes configurable resource pages and resource chains. In certain embodiments, resource chains are a set of alternative resource pages (e.g., HTML pages) which can be displayed to client users depending on whether the rule associated with the resource page applies to the client user. For example, a particular resource chain may have one page for client users who are male, and a different resource page for client users who are female. Resource chains may be accessed, for example, via selectable elements such as a selectable element in navigation panel 208 or a tile such as tile 204. Eligibility for enabling access to the resource chain may be configured using, for example, the functionality of population rule options 1010, and the content displayed in a particular resource page may be provided via the functionality of content editor 1006. In certain embodiments, whether a client user can access a particular resource chain may be configured via the functionality of eligibility options 1008, in order to condition the resource chain on the occurrence of an eligibility trigger event.

In certain embodiments, numerous resources (e.g., messages, incentives, challenges, surveys, customized resource pages, resource chains, and the like) may be configured for a particular group of members. Collectively, these configuration rules and other content may be grouped into a library. In certain embodiments, a library of configuration material may be associated with a single plan year. The service provides administrator tools for copying a library to populate the configuration for, e.g., another group of members or another plan year. In certain embodiments, a master library is used to provide initial configuration options for new group of members (for example, a group of members associated with a particular employer, or an “employer client”). In certain embodiments, updates to a particular resource configuration in the master library will be propagated to the corresponding resource in all libraries based on the master library. In certain embodiments, where a second custom library is based on a first custom library, updates to a particular resource configuration in the first custom library will be propagated to the corresponding resource in the second custom library. In certain embodiments, whether a second custom library will inherit updates from a first custom library (or master library) is itself a configurable option. In certain embodiments, when copying resource configurations from one library to another, an administrator user interface will provide the option to specify whether a resource configuration should be overwritten, maintained, or if a new copy for a resource configuration should be created.

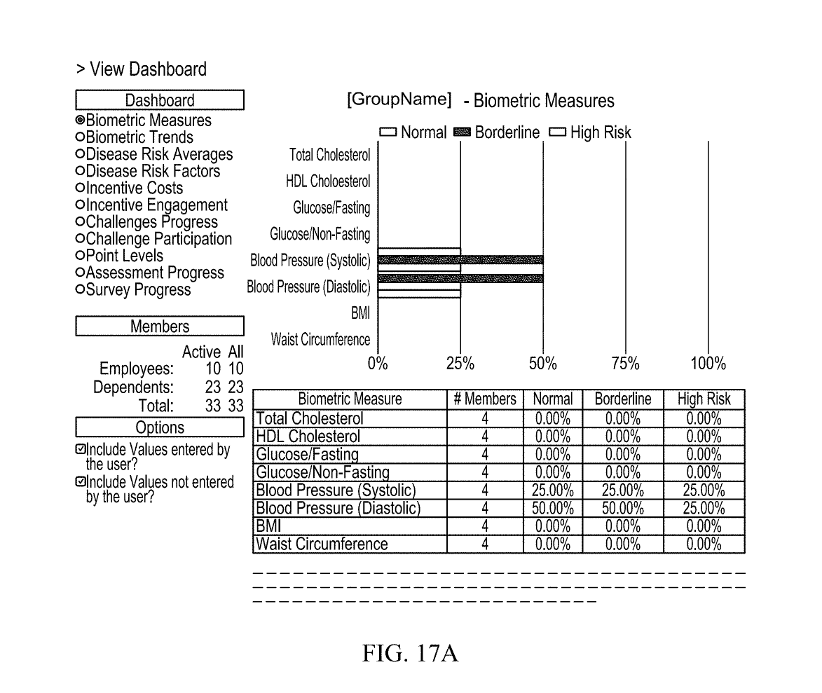

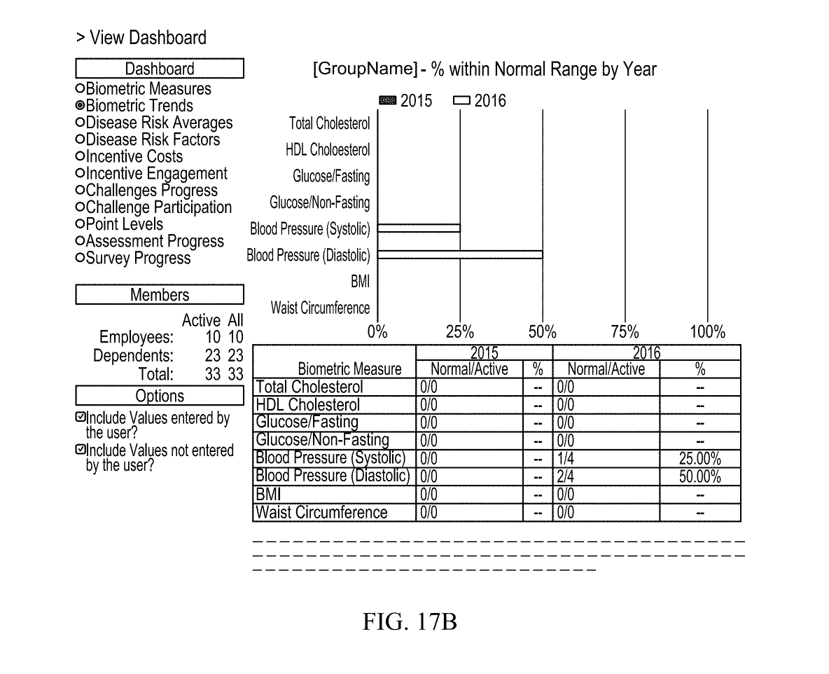

FIGS. 17-21 show exemplary administrator user interfaces for viewing aggregate data describing various aspects of the members of a group. FIG. 17A shows an overview of members with respect to biometric data. In certain embodiments, each biometric measure may be classified into a risk category (e.g., normal, borderline, and high risk). The system may provide quantitative overviews of the aggregated biometric measures in order to reveal the profile of group with respect to the distribution of members into various risk categories. Biometric measures may be obtained via, e.g., a health assessment incentive completed by each client user. FIG. 17B shows an overview of biometric trends for members of a group. The system may provide quantitative overviews of the fraction of normal-risk or active users across two or more benefit years (or other periods of time) for each of a collection of biometric measures. Such an overview may provide an indication of whether the group is becoming more or less healthy, or maintaining a certain level of health with respect to each biometric measure.

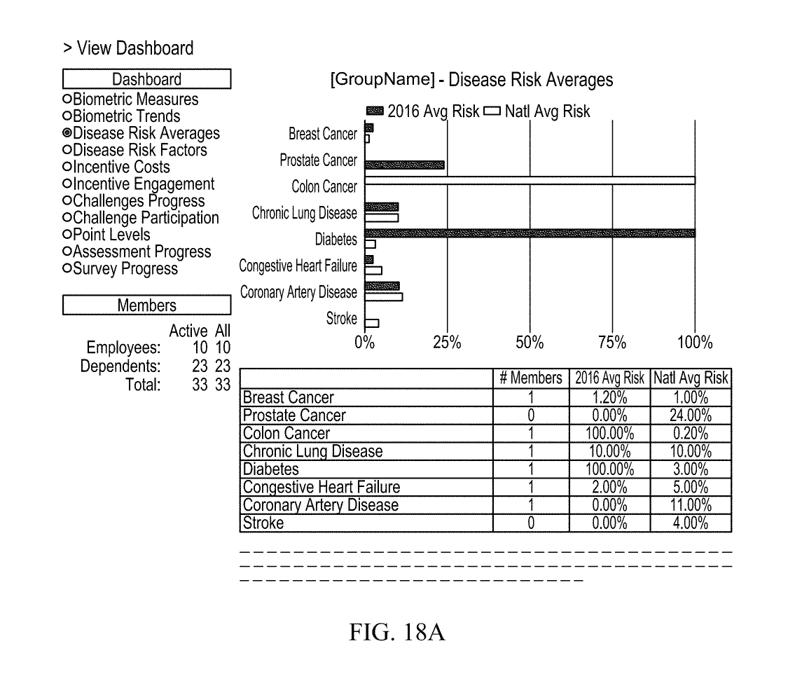

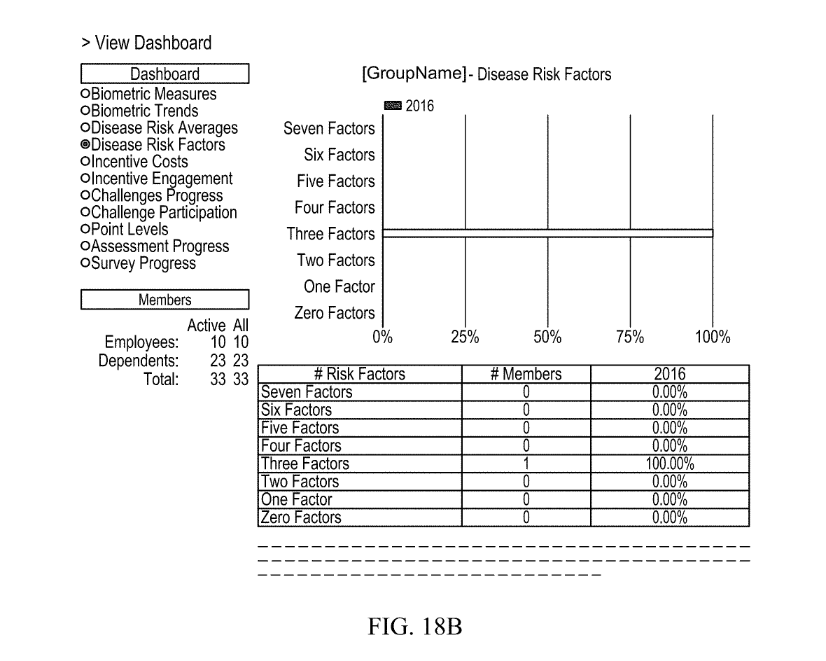

FIG. 18A shows an overview of members with respect to disease risk averages. Disease risk may be calculated from biometric measures as described with respect to FIG. 9C and 9D. FIG. 18B shows an overview of members with respect to counts of disease risk factors. The report lists the percent of members who are currently active and who have entered their biometric values (e.g., via a health assessment incentive), and the values indicate a risk greater than the national average.

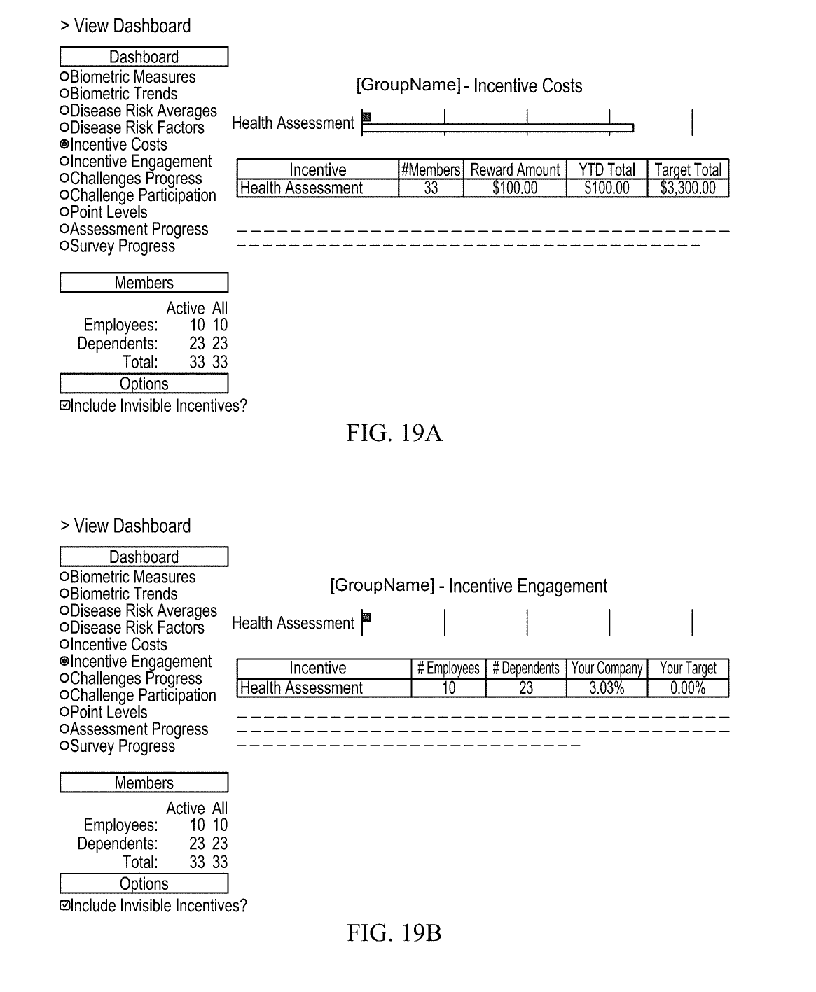

FIG. 19A shows the year-to-date incentive payment totals along with target totals (e.g., based on a participation target provided via an incentive configuration user interface) for members who are currently active or inactive. Such an overview may provide an indication of the expected and current cost for implementing each particular incentive. FIG. 19B shows the percentage and types of members who are engaged with each incentive.

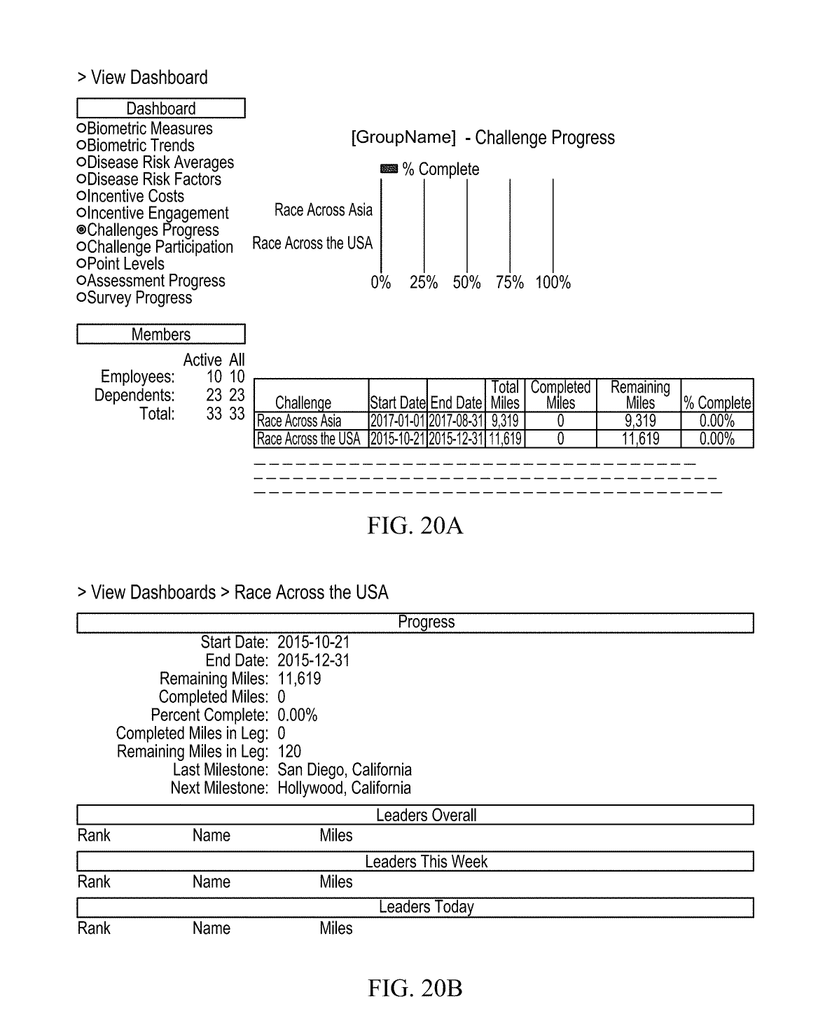

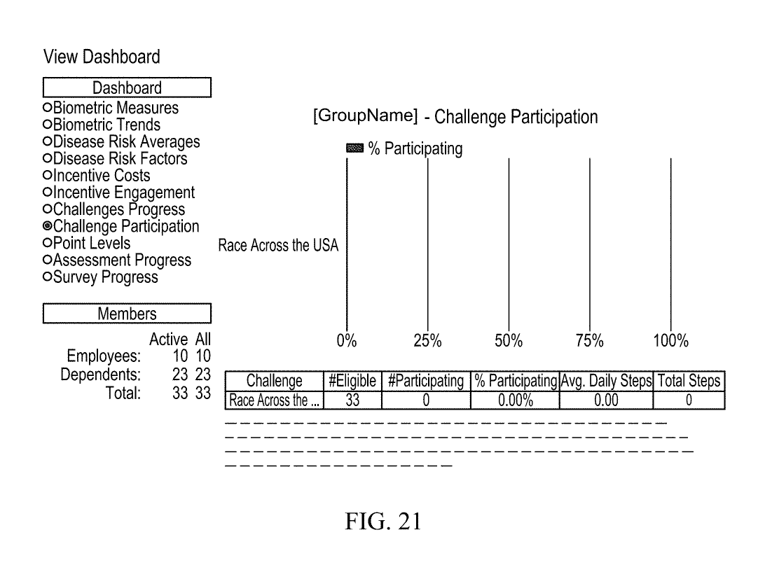

FIG. 20A shows an overview of a group of members' progress with respect to each challenge. FIG. 20B shows specific details regarding progress for a selected challenge. FIG. 21 shows an overview of the percentage of users/members participating in each challenge.

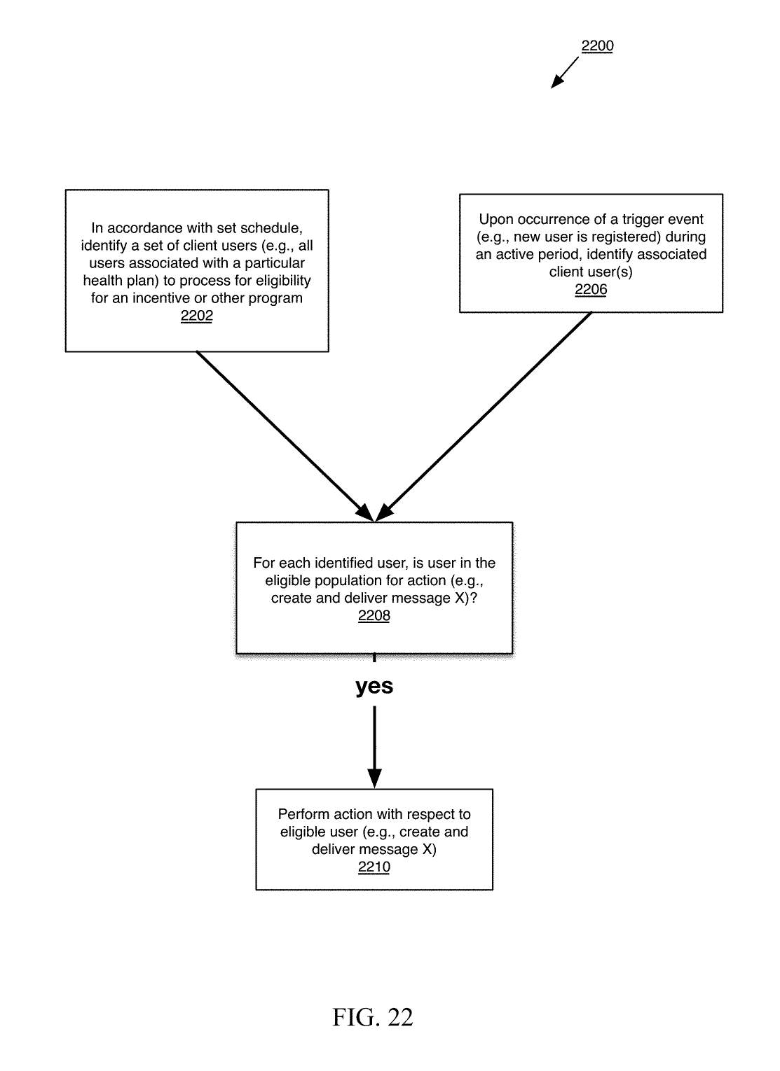

FIG. 22 is a flow chart depicting an exemplary process 2200 for automatically performing an action based on a schedule or the occurrence of a trigger event. As one example, the system may be configured to send a particular message to a category of users at least once during a benefit year—for example, all new female client users aged 50 years or older may receive a message that they are eligible for a mammogram without any copayment. Because eligible members may enroll throughout the benefit year, all eligible members may not be aware of the benefit if the message is sent only once at the beginning of the benefit year. Thus, the system may be configured to deliver the message to eligible members upon a new user registration event, rather than on a particular date. Alternatively, the system may check to see if the message has been delivered to all eligible recipients on a set schedule. Such an action may be configured using process 2200. By way of a user interface such as interface 1000, the system may be configured to assess eligibility in accordance with a specified frequency, using controls such as eligibility options 1008 (2202). For example, the active period during which the system will determine whether to prepare and deliver the message (i.e., the action) may be set to the time period of the benefit year (e.g., Jan. 1, 2016-Dec. 31, 2016), the period during which the exemplary mammogram benefit is available (e.g., the “send period” in user interface 1000). For example, following the exemplary eligibility evaluation schedule set by eligibility options 1008, the system may identify a population of members for eligibility evaluation on a daily basis, or on a weekly basis. In certain embodiments, the group of identified patients/members or client users may correspond to all the client users associated with a particular employer, all the client users associated with a particular health plan, or all the client users in the system.

In another embodiment in which eligibility is evaluated in response to a triggering event, the process may commence upon detection of the occurrence of a specified trigger event. For example, if a registration event is detected, the system may identify the associated new client user who has registered an account (step 2206).

At step 2208, the system may then evaluate whether each of the identified client users are eligible for a specified action—for example, to receive the message using, e.g., a configuration set by population rule options 1010. For example, if a first user is male, and a second user is a female aged 60, only the second user meets the population rules as configured, and in step 2210, the message will be created and delivered to the second user if the second user has not already received the message. In certain embodiments, an action may be delivering a message, changing the information a client user sees upon login (e.g., applicable action banner items 202, tiles 204, resource chains, or notifications/messages in panel 206 presented in a user interface, such as a prompt to enroll in an incentive), sending a request to the user regarding an incentive or to address a care cap, take a quiz, take a survey, provide a reminder, provide a notification regarding a health concern, and the like.

It will be understood that in certain embodiments, the steps of process 2200 may occur in a different order than depicted in FIG. 22.

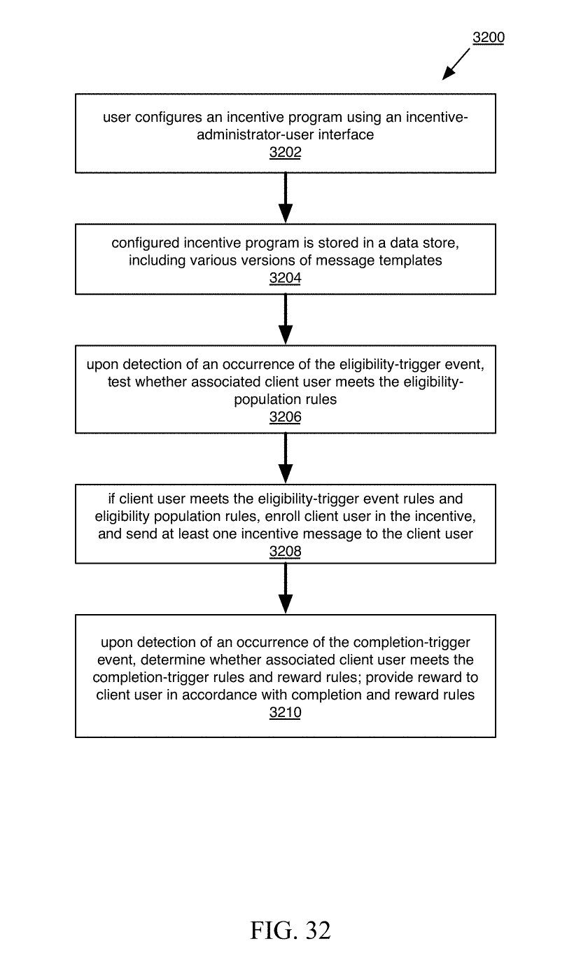

FIG. 32 is a flow chart depicting an exemplary process 3200 for facilitating management of a well-being incentive program, such as a wellness incentive program. An administrator user may configure or save settings that define an incentive program using, for example, the incentive administrator user interfaces 1200, 1205, and 1300 (step 3202). For example, each of the exemplary items listed under the heading “Incentive Name” in user interface 1200 (e.g., “Health Assessment,” “Race Across Asia”) may reference a particular incentive program. A user may save the settings for a particular incentive program to a data store using, for example, user interface 1205 (step 3204). Settings for a single incentive program may configure multiple versions of message templates for generating incentive messages—e.g., for communicating with client users to, for example, invite them to enroll in the incentive, communicate information about a client user's personal and group-wise progress during the incentive, and notify or remind the client user about completing the incentive, and regarding payment of any reward for completing a milestone or incentive program. In certain embodiments, when the system detects the occurrence of an eligibility-trigger event (e.g., an event configured using eligibility options 1008 in user interface 1205), the associated client user will be evaluated to see if the eligibility-population rules are satisfied (e.g., population rule options 1010 configured via user interface 1205) (step 3206). In certain embodiments, eligibility trigger event rules include a requirement that the trigger event has occurred as well as additional rules such as determining whether the trigger event occurred during an active time period, such that the client user will only be enrolled if all of the eligibility trigger rules are satisfied. If the eligibility-population rules are satisfied, the client user may be enrolled in the incentive program (step 3208). In certain embodiments, the client user may be sent a message (e.g., generated using a version of a message template configured as part of the incentive program) to request enrollment, and the client user will only be enrolled in the incentive if the system receives an “opt-in” response from the client user. One or more messages may be generated and sent to client user; such messages may be personalized to an individual client user. When a client user has received a message, it may be made available, for example in a message center, or in some embodiments a version of the message may be sent to an external email address for the client user. When the system detects the occurrence of an event associated with the incentive program as a completion trigger event (e.g., an event configured via completion options 1208 in user interface 1205), the system may evaluate whether both the completion-trigger rules and reward rules have been satisfied. Completion-trigger rules may include whether a completion-trigger event has occurred, as well as additional rules such as whether the incentive has already been completed by this user, and whether the completion-trigger event occurred during an allowable time period. If the completion-trigger rules and reward rules (see, e.g., payment population rules options 1210) are satisfied, a reward may be provided to the client user (step 3210).

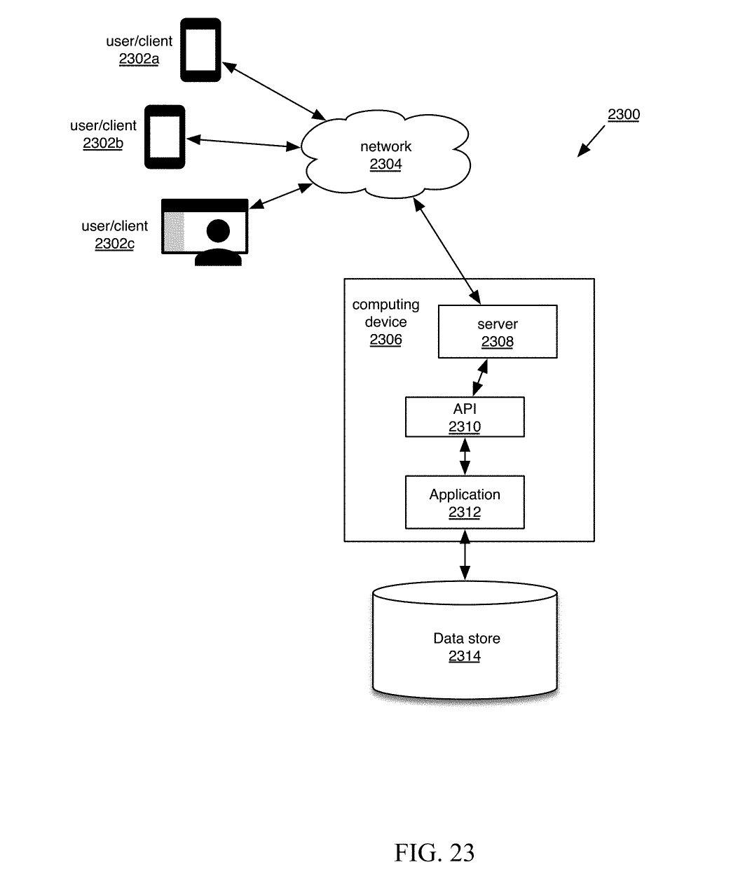

FIG. 23 is a block diagram showing exemplary data flows for an exemplary system 2300. In certain embodiments, client and administrator users access the system via one or more computing devices such as user/client 2302a-c. User/client devices 2302a and 2302b may include mobile devices such as a tablet or smart phone. User/client device 2302c may include a laptop or desktop computer. In certain embodiments, the user/client devices may provide data to one or more computing devices 2306 via network 2304. Network 2304 may include a LAN, wired or wireless network, private or public network, or the internet.

In certain embodiments, one or more computing devices 2306 host a server 2308, such as an HTTP server, and an application 2312 that implements aspects of the service for facilitating user engagement and behavior to improve health outcomes. User attributes and related health information may be stored in data store 2314. In certain embodiments, there may be multiple data stores for storing various categories of relationships, such as a data store of health care providers and their associated practice types, or abilities to handle particular categories of care gaps. Application 2312 may support an Application Programming Interface (API) 2310 providing external access to methods for accessing data store 2314. The data store may be a database, for example storing client user/member attributes and provider information in different tables. In certain embodiments, the database may be a relational database, a key-value database, an XML database, or a distributed database. In certain embodiments, client applications running on on user/client devices 2302 may access API 2310 via server 2308 using protocols such as HTTP or FTP.

Below are set out hardware (e.g., machine) and software architectures that may be deployed in the systems described above, in various example embodiments.

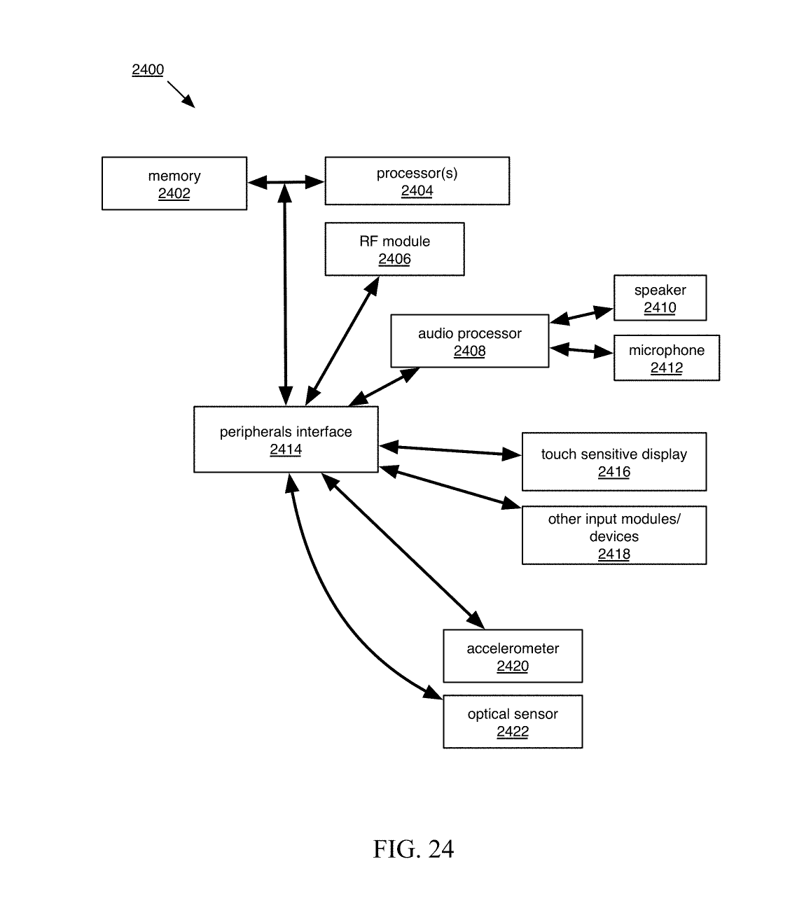

FIG. 24 is a block diagram showing an exemplary mobile computing device. The device 2400 may have a memory 2402 which may include one or more types of computer readable medium, such as RAM, optical storage devices, or flash memory. Memory 2402 may store an operating system, applications, and communication procedures. Device 2400 may include one or more data processors, image processors, or central processing units 2404. Device 2400 may include peripherals interface 2414 coupled to RF module 2406, audio processor 2408, touch sensitive display 2416, other input modules/devices 2418, accelerometer 2420 and optical sensor 2422.

RF module 2406 may include a cellular radio, Bluetooth radio, NFC radio, WLAN radio, GPS receiver, and antennas used by each for communicating data over various networks.

Audio processor 2408 may be coupled to a speaker 2410 and microphone 2412. Touch sensitive display 2416 receives touch-based input. Other input modules or devices 1018 may include, for example, a stylus, voice recognition via microphone 2412, or an external keyboard.

Accelerometer 2420 may be capable of detecting changes in orientation of the device, or movements due to the gait of a user. Optical sensor 2422 may sense ambient light conditions, and acquire still images and video.

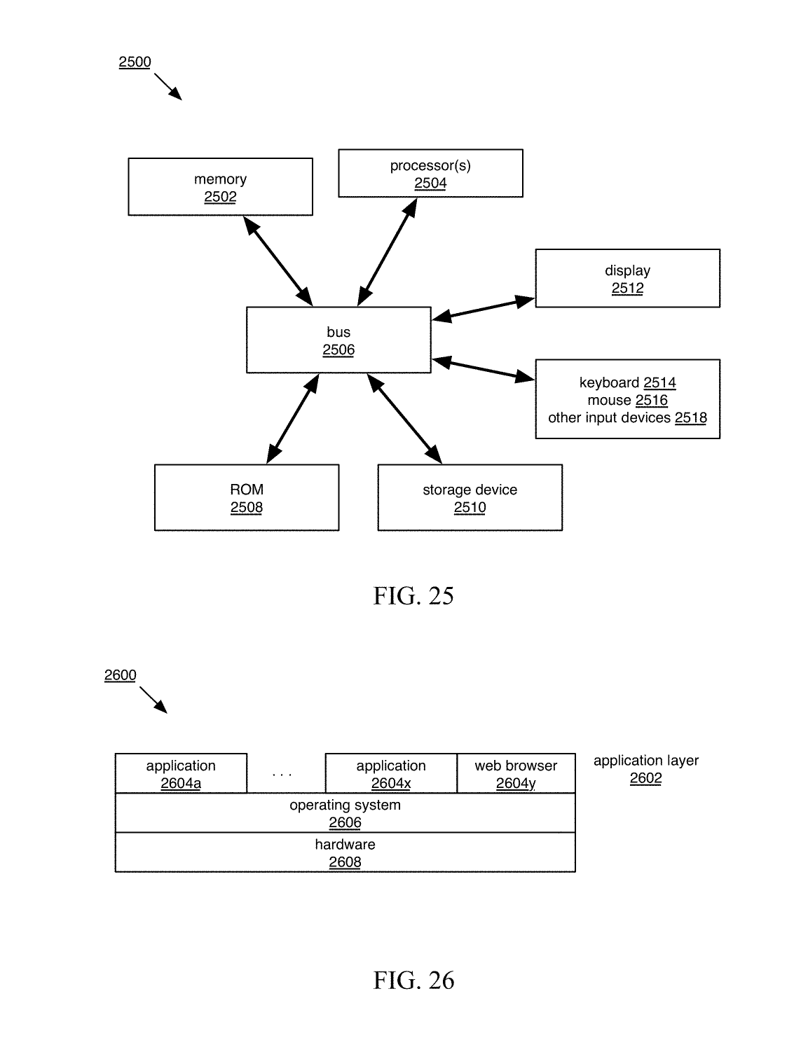

FIG. 25 is a block diagram showing an exemplary computing system 2500 that is representative any of the computer systems or electronic devices discussed herein. Note, not all of the various computer systems have all of the features of system 2500. For example, systems may not include a display inasmuch as the display function may be provided by a client computer communicatively coupled to the computer system or a display function may be unnecessary.

System 2500 includes a bus 2506 or other communication mechanism for communicating information, and a processor 2504 coupled with the bus 2506 for processing information. Computer system 2500 also includes a main memory 2502, such as a random access memory or other dynamic storage device, coupled to the bus 2506 for storing information and instructions to be executed by processor 2504. Main memory 2502 also may be used for storing temporary variables or other intermediate information during execution of instructions to be executed by processor 2504.

System 2500 includes a read only memory 2508 or other static storage device coupled to the bus 2506 for storing static information and instructions for the processor 2504. A storage device 2510, which may be one or more of a hard disk, flash memory-based storage medium, magnetic tape or other magnetic storage medium, a compact disc (CD)-ROM, a digital versatile disk (DVD)-ROM, or other optical storage medium, or any other storage medium from which processor 2504 can read, is provided and coupled to the bus 2506 for storing information and instructions (e.g., operating systems, applications programs and the like).

Computer system 2500 may be coupled via the bus 2506 to a display 2512 for displaying information to a computer user. An input device such as keyboard 2514, mouse 2516, or other input devices 2518 may be coupled to the bus 2506 for communicating information and command selections to the processor 2504.

The processes referred to herein may be implemented by processor 2504 executing appropriate sequences of computer-readable instructions contained in main memory 2504. Such instructions may be read into main memory 2504 from another computer-readable medium, such as storage device 2510, and execution of the sequences of instructions contained in the main memory 2504 causes the processor 2504 to perform the associated actions. In alternative embodiments, hard-wired circuitry or firmware-controlled processing units (e.g., field programmable gate arrays) may be used in place of or in combination with processor 2504 and its associated computer software instructions to implement the invention. The computer-readable instructions may be rendered in any computer language including, without limitation, Python, Objective C, C#, C/C++, Java, Javascript, assembly language, markup languages (e.g., HTML, XML), and the like. In general, all of the aforementioned terms are meant to encompass any series of logical steps performed in a sequence to accomplish a given purpose, which is the hallmark of any computer-executable application. Unless specifically stated otherwise, it should be appreciated that throughout the description of the present invention, use of terms such as “processing”, “computing”, “calculating”, “determining”, “displaying”, “receiving”, “transmitting” or the like, refer to the action and processes of an appropriately programmed computer system, such as computer system 2500 or similar electronic computing device, that manipulates and transforms data represented as physical (electronic) quantities within its registers and memories into other data similarly represented as physical quantities within its memories or registers or other such information storage, transmission or display devices.

FIG. 26 illustrates a computer system 2600 from the point of view of its software architecture. Computer system 2600 may be any of the electronic devices or, with appropriate applications comprising a software application layer 2602, may be a computer system for use with the services described herein. The various hardware components of computer system 2600 are represented as a hardware layer 2608. An operating system 2606 abstracts the hardware layer and acts as a host for various applications 2604, that run on computer system 2600. The operating system may host a web browser application 2604y, which may provide access for the user interfaces, etc.

The foregoing description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” and the like are used merely as labels, and are not intended to impose numerical requirements on their objects.

What is claimed is:

1. A system for facilitating client user responses to care goals, comprising:
one or more processors connected to one or more storage devices and a network interface, the one or more storage devices storing processor-executable instructions that, when executed by the one or more processors, cause the one or more processors to provide configuration instructions for configuring a care-goal-administrator-user interface for composing care-goal-type-message templates concerning a care-goal type over the network interface, the care-goal-administrator-user interface comprising:
editing tools for composing content including text and graphics; and
interactive response controls for configuring response-input elements for directly receiving response input from a recipient client user;
the processor-executable instructions further causing the one or more processors to:
receive and store a care-goal-type-message template composed using the care-goal-administrator-user interface, wherein the care-goal-type-message template comprises a response-input element capable of receiving an affirmation that a request has been completed;
receive information regarding one or more care goals having the care-goal type for one or more client users;
for each respective client user of the one or more client users:
generate a care-goal message using the care-goal-type-message template;
deliver the care-goal message for display to the respective client user in a client-user interface over the network interface.

2. The system of claim 1, further comprising:
for each respective client user of the one or more client users:
determine the respective client-user-response status in accordance with whether the system has received the affirmation from the respective client user via the client-user interface; and
if the client-user-response status indicates the client user has not affirmed that the request has been completed, automatically schedule a follow-up communication regarding the respective care gap; otherwise do not schedule the follow-up communication.

3. The system of claim 1, wherein the one or more processors further provide configuration instructions for configuring a care-goal-dashboard-client-user interface for displaying a listing of selectable elements, such that each respective selectable element, upon selection, provides information about a care goal.

4. The system of claim 2, wherein the care-goal-administrator-user interface further comprises sequence message controls for composing a follow-up message template, including controls for specifying:
the content of a respective follow-up message to be generated using the follow-up message template, respective client user attributes to include in the follow-up message content, an event for tolling a lag time period after which the message is delivered, and the length of the lag time period; and
wherein the follow-up communication is generated using the follow-up message template.

5. The system of claim 4, wherein the event for tolling a lag time period is the date on which the respective client user views the care-goal message.

6. The system of claim 2, wherein the care goal message or the follow-up communication includes a listing regarding a recommended provider that is determined using a data store associating the care-goal type and the geographic area of the respective client user.

7. The system of claim 1, wherein the care-goal-type-message template response-input element further includes an input field for client user comments.

8. The system of claim 1, wherein the care goal is a care gap, and the request is for the client user to contact a doctor about the care cap or obtain over-the-counter care for the care gap.

9. The system of claim 1, wherein the care-goal-type-message template includes conditional content that is displayed or not displayed in accordance with the value of one or more client user attributes, and the care goal message is generated by inserting the value of a variable.

10. The system of claim 1, wherein the care-goal-administrator-user interface further comprises population-rule controls for configuring whether a client user is eligible to receive the care-goal message, wherein the population-rule controls are capable of specifying a rule that must evaluate two or more variables in the same expression, and wherein the one or more client users is the set of client users who satisfy a population rule that was configured using the population-rule controls of the care-goal-administrator-user interface.

11. The system of claim 1, wherein the information regarding one or more care goals is received in real time.

12. The system of claim 1, wherein the information regarding one or more care goals is automatically retrieved from a network location according to a set schedule.

13. A system for facilitating management of well-being incentive programs, comprising:
one or more processors connected to one or more storage devices and a network interface, the one or more storage devices storing processor-executable instructions that, when executed by the one or more processors, cause the one or more processors to provide instructions for configuring an incentive-administrator-user interface for defining incentive programs over the network interface, the incentive-administrator-user interface comprising:
editing tools for composing incentive-message-template content including text and graphics;
eligibility-trigger-event controls for configuring eligibility-trigger-event rules regarding an eligibility-trigger event;
eligibility-population-rule controls for configuring eligibility-population rules regarding whether a client user is eligible to enroll in an incentive, wherein the eligibility-population-rule controls are capable of specifying a rule that must evaluate two or more variables in the same expression;
completion-trigger-event controls for configuring completion-trigger-event rules regarding a completion-trigger event; and
reward controls for configuring reward rules regarding a reward for completing the incentive;
the instructions further causing the one or more processors to:
receive and store one or more versions of the incentive-message-template content, the eligibility-trigger-event rules, the eligibility-population rules, the completion-trigger-event rules, and the reward rules collectively as an incentive program, wherein the content and rules of the incentive program were configured using the incentive-administrator-user interface;
detect an occurrence of the eligibility-trigger event associated with a client user;
if the client user meets the eligibility-trigger-event rules:
responsive to detection of an occurrence of the eligibility-trigger event, generate an incentive message using a version of the incentive-message-template content and
deliver the incentive message for display in a client-user interface over the network interface;
detect an occurrence of the completion-trigger event associated with the client user;
if the client user meets the completion-trigger-event rules and the reward rules:
responsive to detection of the completion-trigger event, provide the reward to the client user;
otherwise, do not provide the reward to the client user; and
otherwise, do not enroll the client user in the incentive program.

14. The system of claim 13, wherein the incentive-administrator-user interface controls further comprise a control to limit the number of times the client user may participate in the incentive program.

15. The system of claim 13, wherein the incentive program is configured to receive information from a fitness tracker, and the fitness tracker information is used to detect the occurrence of the completion trigger event.

16. The system of claim 13, wherein the eligibility-trigger event is logging in, registering a new client user account, updating activity data, or linking an activity tracker.

17. The system of claim 13, wherein the completion-trigger event is completing a survey, completing a challenge milestone, or registering that a care gap was closed.

18. The system of claim 13, wherein a reward may be a cash payment, a gift card, or points.

19. The system of claim 13, wherein the eligibility-trigger-event rules include an evaluation schedule having a frequency and a start date.

20. The system of claim 13, the instructions further causing the one or more processors to:
deliver an updated incentive message to all client users who are enrolled in the incentive.

21. The system of claim 13, wherein the incentive-administrator-user interface controls further comprise interactive response controls for configuring response-input elements for directly receiving response input in the incentive message from a recipient client user.

22. The system of claim 13, wherein the eligibility-population-rule controls and the reward controls provide drop-down menus for constructing rules that operate on variables corresponding to one or more of client user attributes, health statistics, gaps in care, health risks, health assessment answers, incentives, reimbursements, quizzes, and activity plan levels.
